(19) United States
(12) Patent Application Publication
(10) Pub. No.: US 2025/0193530 A1
(43) Pub. Date: Jun. 12, 2025

(54) CONTROL DEVICE, CONTROL METHOD, AND PROGRAM

(71) Applicant: FUJIFILM Corporation, Tokyo (JP)

(72) Inventor: Tetsu WADA, Saitama-shi (JP)

(73) Assignee: FUJIFILM Corporation, Tokyo (JP)

(21) Appl. No.: 19/061,953

(22) Filed: Feb. 24, 2025

Related U.S. Application Data
(63) Continuation of application No. PCT/JP2023/017455, filed on May 9, 2023.

(30) Foreign Application Priority Data
Aug. 30, 2022 (JP) 2022-137267

(51) Int. Cl. H04N 23/74; B64U 10/13; B64U 101/30; H04N 23/71; H04N 23/72; H04N 23/73

(52) U.S. Cl. CPC H04N 23/74; H04N 23/71; H04N 23/72; H04N 23/73; B64U 10/13; B64U 2101/30

(57) ABSTRACT

A control device is a control device applied to a moving object equipped with an imaging apparatus and a light source. The imaging apparatus images a first imaging target region and a second imaging target region of a subject according to a movement position of the moving object. A first region that is a part of the first imaging target region overlaps with a second region that is a part of the second imaging target region. The control device includes a processor. The processor is configured to perform control of causing the light source to irradiate the first imaging target region with light. An intensity of the light with which the first region is irradiated is higher than an intensity of the light with which a periphery of the first region is irradiated.

This application is a continuation application of International Application No. PCT/JP2023/017455, filed May 9, 2023, the disclosure of which is incorporated herein by reference in its entirety. Further, this application claims priority under 35 USC 119 from Japanese Patent Application No. 2022-137267 filed Aug. 30, 2022, the disclosure of which is incorporated by reference herein.

### BACKGROUND OF THE INVENTION

### 1. Field of the Invention

The technology of the present disclosure relates to a control device, a control method, and a program.

### 2. Description of the Related Art

WO2019/150872A discloses an image processing apparatus comprising an image input unit, a damage detection unit, an image decision unit, a display control unit, and a detection result correction unit. The image input unit inputs a plurality of images obtained by performing split imaging on a subject. The damage detection unit detects damage to the subject from an individual image that is an image individually constituting the plurality of images. The image decision unit decides whether or not to set the individual image as a check target image for a user to check a detection result for the individual image. The display control unit causes a display device to display the check target image or a partial image, which is obtained by cutting out a partial region of the check target image in accordance with a display region of the display device, in association with a detection result in the check target image or the partial image. The detection result correction unit corrects the detection result based on an instruction input from the user.

JP2020-155902A discloses an imaging apparatus that images a subject in a state of being provided in a moving object. The imaging apparatus includes a plurality of illumination imaging units that respectively image different ranges on the subject in a direction intersecting a movement direction of the moving object. Each of the plurality of illumination imaging units includes an illumination unit that illuminates at least a part of an illumination range on the subject, and an imaging unit that images a region included in the illumination range. The imaging apparatus images non-overlapping regions in which respective illumination ranges of the plurality of illumination imaging units do not overlap with each other on the subject.

JP2022-007039A discloses an imaging apparatus comprising two light sources, an imaging element, a control unit, a specifying unit, and a processing unit. The imaging element images a subject with light emitted from the two light sources and reflected by the subject. The control unit controls a light emission timing of each of the two light sources and an exposure timing of the imaging element to acquire a first image obtained by capturing the subject with the imaging element using only a first light source of the two light sources and a second image obtained by capturing the subject with the imaging element using only a second light source of the two light sources. The specifying unit specifies a region in which overexposure occurs in the first image as an overexposure region. The processing unit performs processing of compositing an image of a region other than the overexposure region in the first image and an image of a region corresponding to the overexposure region in the second image to generate a composite image, and outputs the generated composite image.

### SUMMARY OF THE INVENTION

One embodiment according to the technology of the present disclosure provides, for example, a control device, a control method, and a program capable of obtaining an image that contributes to ensuring appropriate brightness of an entire composite image as an image used to generate the composite image.

A first aspect according to the technology of the present disclosure is a control device applied to a moving object equipped with an imaging apparatus and a light source, in which the imaging apparatus images a first imaging target region and a second imaging target region of a subject according to a movement position of the moving object, and a first region that is a part of the first imaging target region overlaps with a second region that is a part of the second imaging target region. The control device comprises a processor, in which the processor is configured to perform control of causing the light source to irradiate the first imaging target region with light, and an intensity of the light with which the first region is irradiated is higher than an intensity of the light with which a periphery of the first region is irradiated.

A second aspect according to the present disclosed technology is the control device according to the first aspect, in which the processor is configured to composite a first captured image obtained by imaging the first imaging target region and a second captured image obtained by imaging the second imaging target region to generate a composite image, and use, in a case where the composite image is generated, a pixel value of an image region corresponding to the second region in the second captured image as a pixel value of an overlap image region corresponding to the first region and the second region in the composite image.

A third aspect according to the technology of the present disclosure is the control device according to the first aspect or the second aspect, in which the control includes control of making an image of the light source fit in an image region corresponding to the first region in a first captured image obtained by imaging the first imaging target region.

A fourth aspect according to the technology of the present disclosure is the control device according to any one of the first to third aspects, in which the imaging apparatus includes an image sensor having a light-receiving surface, and the processor is configured to, in a case where the imaging apparatus images the first imaging target region, adjust an exposure amount of the light-receiving surface based on brightness of a third region other than the first region of the first imaging target region.

A fifth aspect according to the technology of the present disclosure is the control device according to the fourth aspect, in which the exposure amount is adjusted by changing an irradiation position and/or an intensity of the light.

A sixth aspect according to the technology of the present disclosure is the control device according to the fourth aspect, in which the exposure amount is adjusted by changing exposure to the light-receiving surface.

A seventh aspect according to the technology of the present disclosure is the control device according to any one of the fourth aspect to the sixth aspect, in which the exposure amount is set to an exposure amount at which a pixel value of an image region corresponding to the first region in a first captured image obtained by imaging the first imaging target region is equal to or larger than a first default pixel value.

An eighth aspect according to the technology of the present disclosure relates to the control device according to the seventh aspect, in which the first default pixel value is set to a pixel value at which a pixel value of at least a part of the image region is saturated.

A ninth aspect according to the present disclosed technology is the control device according to the seventh or eighth aspect, in which the first imaging target region and the second imaging target region are regions that are imaged in an order of the first imaging target region and the second imaging target region, and the processor is configured to acquire a length of the first region along a movement direction of the moving object based on the pixel value of the image region, and move, based on the length, the moving object to a position where the first region and the second region overlap each other.

A tenth aspect according to the technology of the present disclosure is the control device according to any one of the seventh to ninth aspects, in which the exposure amount is set to an exposure amount at which a pixel value of an image region corresponding to the third region in the first captured image is equal to or larger than a second default pixel value and less than the first default pixel value.

An eleventh aspect according to the technology of the present disclosure is the control device according to the tenth aspect, in which an overlap amount with which the first region and the second region overlap is a default overlap amount.

A twelfth aspect according to the technology of the present disclosure is the control device according to any one of the first to eleventh aspects, in which the light source is disposed on a front side of the moving object in a movement direction with respect to the imaging apparatus, and the first imaging target region and the second imaging target region are regions that are imaged in an order of the first imaging target region and the second imaging target region.

A thirteenth aspect according to the technology of the present disclosure is the control device according to any one of the first to eleventh aspects, in which the light source is disposed on a rear side of the moving object in a movement direction with respect to the imaging apparatus, and the first imaging target region and the second imaging target region are regions that are imaged in an order of the second imaging target region and the first imaging target region.

A fourteenth aspect according to the present disclosed technology is the control device according to any one of the first to thirteenth aspects, in which the processor is configured to, in a case where the imaging apparatus images the second imaging target region, perform control of causing the light source to irradiate the second imaging target region with the light, and an intensity of the light with which a fourth region on a side opposite to the second region of the second imaging target region is irradiated is higher than an intensity of the light with which a periphery of the fourth region is irradiated.

A fifteenth aspect according to the technology of the present disclosure is the control device according to any one of the first to fourteenth aspects, in which light irradiation is performed along a normal direction of the first region.

A sixteenth aspect according to the technology of the present disclosure is the control device according to any one of the first to fifteenth aspects, in which the control is control of causing the light source to be in a state of performing irradiation with the light in a case where the moving object is moved to a position where the imaging apparatus images the first imaging target region.

A seventeenth aspect according to the technology of the present disclosure is the control device according to any one of the first to fifteenth aspects, in which the control is control of causing the light source to perform irradiation with the light in a case where the moving object is moved to a position where the imaging apparatus images the first imaging target region.

An eighteenth aspect according to the present disclosed technology is a control method applied to a moving object equipped with an imaging apparatus and a light source, in which the imaging apparatus images a first imaging target region and a second imaging target region of a subject according to a movement position of the moving object, and a first region that is a part of the first imaging target region overlaps with a second region that is a part of the second imaging target region. The control method comprises performing control of causing the light source to irradiate the first imaging target region with light, in which an intensity of the light with which the first region is irradiated is higher than an intensity of the light with which a periphery of the first region is irradiated.

A nineteenth aspect according to the technology of the present disclosure is a program for causing a computer, which is applied to a moving object equipped with an imaging apparatus and a light source, to execute a process, in which the imaging apparatus images a first imaging target region and a second imaging target region of a subject according to a movement position of the moving object, and a first region that is a part of the first imaging target region overlaps with a second region that is a part of the second imaging target region. The process comprises performing control of causing the light source to irradiate the first imaging target region with light, in which an intensity of the light with which the first region is irradiated is higher than an intensity of the light with which a periphery of the first region is irradiated.

### BRIEF DESCRIPTION OF THE DRAWINGS

FIG. 1 is a front view of an example of an aspect in which a flight imaging apparatus according to a first embodiment sequentially images a plurality of imaging target regions.

FIG. 2 is a block diagram showing an example of a hardware configuration of the flight imaging apparatus according to the first embodiment.

FIG. 3 is a block diagram showing an example of a hardware configuration of an imaging apparatus according to the first embodiment.

FIG. 4 is a two-view diagram showing an example of an aspect in which an N-th imaging target region and an (N+1)-th imaging target region are regions that are imaged according to a flying position of the flight imaging apparatus according to the first embodiment.

FIG. 5 is a block diagram showing an example of a functional configuration for realizing flight imaging processing according to the first embodiment.

FIG. 6 is a block diagram showing an example of operations of a lighting control unit and a first reach determination unit according to the first embodiment.

FIG. 7 is a block diagram showing an example of operations of the first reach determination unit, a first imaging control unit, a first brightness acquisition unit, and a first exposure amount derivation unit according to the first embodiment.

FIG. 8 is a block diagram showing an example of operations of the first exposure amount derivation unit, a second imaging control unit, and a width acquisition unit according to the first embodiment.

FIG. 9 is a block diagram showing an example of operations of the width acquisition unit, an imaging position correction unit, and a second reach determination unit according to the first embodiment.

FIG. 10 is a block diagram showing an example of operations of the second reach determination unit, a third imaging control unit, a second brightness acquisition unit, and a second exposure amount derivation unit according to the first embodiment.

FIG. 11 is a block diagram showing an example of operations of the second exposure amount derivation unit and a fourth imaging control unit according to the first embodiment.

FIG. 12 is a block diagram showing an example of operations of an end determination unit and an extinguishing control unit according to the first embodiment.

FIG. 13 is a block diagram showing an example of a functional configuration for realizing composite image generation processing according to the first embodiment.

FIG. 14 is a block diagram showing an example of operations of an image acquisition unit and an image composition unit according to the first embodiment.

FIG. 15 is a flowchart showing an example of a flow of the flight imaging processing according to the first embodiment.

FIG. 16 is a flowchart showing an example of a flow of the composite image generation processing according to the first embodiment.

FIG. 17 is a block diagram showing an example of operations of the first exposure amount derivation unit, a light source control unit, and the second imaging control unit according to a second embodiment.

FIG. 18 is a two-view diagram showing an example of an aspect in which an N-th imaging target region and an (N+1)-th imaging target region are regions that are imaged according to a flying position of the flight imaging apparatus according to a third embodiment.

FIG. 19 is a block diagram showing an example of operations of the second exposure amount derivation unit, the light source control unit, and the fourth imaging control unit according to the third embodiment.

FIG. 20 is a block diagram showing an example of operations of the image acquisition unit and the image composition unit according to the third embodiment.

FIG. 21 is a front view of an example of an aspect in which the flight imaging apparatus according to the fourth embodiment sequentially images a plurality of imaging target regions.

FIG. 22 is a two-view diagram showing an example of an aspect in which an N-th imaging target region and an (N+1)-th imaging target region are regions that are imaged in a case where the flight imaging apparatus according to the fourth embodiment flies to a first side. FIG. 23 is a two-view diagram showing an example of an aspect in which an N-th imaging target region and an (N+1)-th imaging target region are regions that are imaged in a case where the flight imaging apparatus according to the fourth embodiment flies to a second side.

FIG. 24 is a front view of an example of an aspect in which the flight imaging apparatus according to a fifth embodiment sequentially images a plurality of imaging target regions while flying along an N-th flight route.

FIG. 25 is a front view of an example of an aspect in which the flight imaging apparatus according to the fifth embodiment sequentially images a plurality of imaging target regions while flying along an (N+1)-th flight route.

FIG. 26 is a block diagram showing an example of operations of the image acquisition unit and the image composition unit according to the fifth embodiment.

FIG. 27 is a front view of an example of an aspect in which the flight imaging apparatus according to a sixth embodiment sequentially images a plurality of imaging target regions while flying along an N-th flight route.

FIG. 28 is a front view of an example of an aspect in which the flight imaging apparatus according to the sixth embodiment sequentially images a plurality of imaging target regions while flying along an (N+1)-th flight route.

FIG. 29 is a block diagram showing an example of operations of the image acquisition unit and the image composition unit according to the sixth embodiment.

### DESCRIPTION OF THE PREFERRED EMBODIMENTS

Hereinafter, an example of embodiments of a control device, a control method, and a program according to the technology of the present disclosure will be described with reference to accompanying drawings. First, terms used in the following description will be described.

I/F refers to an abbreviation for “interface”. RAM refers to an abbreviation for “random access memory”. CPU refers to an abbreviation for “central processing unit”. GPU refers to an abbreviation for “graphics processing unit”. HDD refers to an abbreviation for “hard disk drive”. SSD refers to an abbreviation for “solid state drive”. DRAM refers to an abbreviation for “dynamic random access memory”. SRAM refers to an abbreviation for “static random access memory”. GNSS refers to an abbreviation for “global navigation satellite system”. GPS refers to an abbreviation of “global positioning system”. LiDAR refers to an abbreviation for “light detection and ranging”. NVM indicates the abbreviation for “non-volatile memory”. ASIC refers to an abbreviation for “application specific integrated circuit”. FPGA refers to an abbreviation for “field-programmable gate array”. PLD refers to an abbreviation for “programmable logic device”. CMOS refers to an abbreviation for “complementary metal oxide semiconductor”. CCD refers to an abbreviation for “charge coupled device”. RGB refers to an abbreviation for “red green blue”. CIE refers to an abbreviation for “Commission Internationale de l′Eclairage”. TPU refers to an abbreviation for “tensor processing unit”. USB refers to an abbreviation for “universal serial bus”. SoC refers to an abbreviation of a “system-on-a-chip”. IC refers to an abbreviation for “integrated circuit”.

In the description of the present specification, a term “vertical direction” refers to, in addition to a complete vertical direction, a vertical direction generally allowed in the technical field to which the technology of the present disclosure belongs, the vertical direction in a sense of including an error to the extent that the error does not contradict the gist of the technology of the present disclosure. In the description of the present specification, a term “horizontal direction” refers to, in addition to a complete horizontal direction, a horizontal direction generally allowed in the technical field to which the technology of the present disclosure belongs, the horizontal direction in a sense of including an error to the extent that the error does not contradict the gist of the technology of the present disclosure. In the description of the present specification, a term “quadrangle” refers to, in addition to a complete quadrangle, a quadrangle generally allowed in the technical field to which the technology of the present disclosure belongs, the quadrangle in a sense of including an error to the extent that the error does not contradict the gist of the technology of the present disclosure. In the description of the present specification, a term “perpendicular” refers to, in addition to a complete perpendicular, a perpendicular generally allowed in the technical field to which the technology of the present disclosure belongs, the perpendicular in a sense of including an error to the extent that the error does not contradict the gist of the technology of the present disclosure. In the description of the present specification, a term “being constant” refers to, in addition to being completely constant, being constant generally allowed in the technical field to which the technology of the present disclosure belongs, the being constant in a sense of including an error to the extent that the error does not contradict the gist of the technology of the present disclosure. In the description of the present specification, a term “overlap” refers to, in addition to a complete overlap, an overlap generally allowed in the technical field to which the technology of the present disclosure belongs, the overlap in a sense of including an error to the extent that the error does not contradict the gist of the technology of the present disclosure. In the description of the present specification, a term “center” refers to, in addition to a complete center, a center generally allowed in the technical field to which the technology of the present disclosure belongs, the center in a sense of including an error to the extent that the error does not contradict the gist of the technology of the present disclosure. In the description of the present specification, a term “maximum value” refers to, in addition to a complete maximum value, a maximum value generally allowed in the technical field to which the technology of the present disclosure belongs, the maximum value in a sense of including an error to the extent that the error does not contradict the gist of the technology of the present disclosure. In the description of the present specification, a term “minimum value” refers to, in addition to a complete minimum value, a minimum value generally allowed in the technical field to which the technology of the present disclosure belongs, the minimum value in a sense of including an error to the extent that the error does not contradict the gist of the technology of the present disclosure. In the description of the present specification, a term “central value” refers to, in addition to a complete central value, a central value generally allowed in the technical field to which the technology of the present disclosure belongs, the central value in a sense of including an error to the extent that the error does not contradict the gist of the technology of the present disclosure. In the description of the present specification, a term “average value” refers to, in addition to a complete average value, an average value generally allowed in the technical field to which the technology of the present disclosure belongs, the average value in a sense of including an error to the extent that the error does not contradict the gist of the technology of the present disclosure.

### First Embodiment

First, a first embodiment will be described.

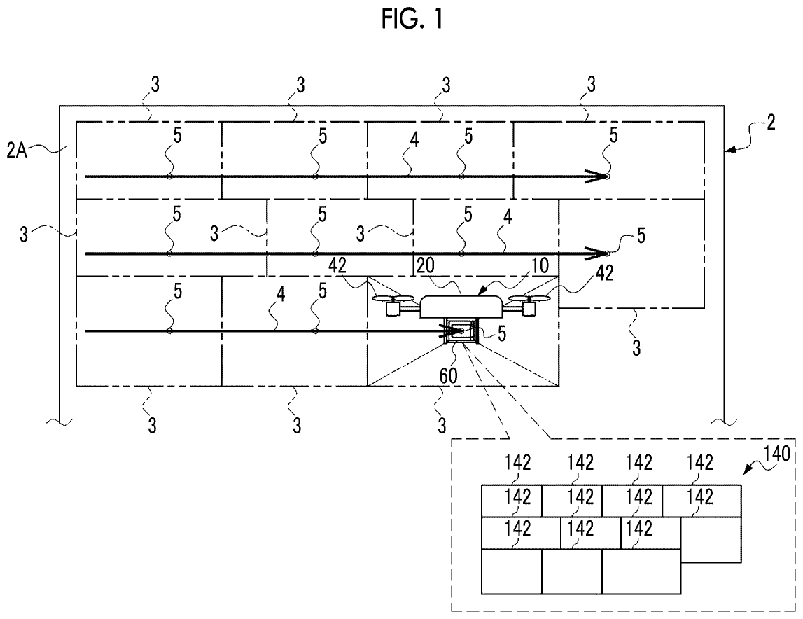

As shown in FIG. 1 as an example, a flight imaging apparatus 10 has a flight function and an imaging function, and images a wall surface 2A of an object 2 while flying. In the description of the present specification, the concept of “flight” includes not only the meaning that the flight imaging apparatus 10 moves in the air but also the meaning that the flight imaging apparatus 10 is stopped in the air. The flight imaging apparatus is an example of “mobile imaging apparatus” according to the technology of the present disclosure.

As an example, the object 2 having the wall surface 2A is a pier provided in a bridge. The pier is made of, for example, reinforced concrete. Here, the pier is exemplified as an example of the object 2, but the object 2 may be an object (for example, tunnel or dam) other than the pier.

The flight imaging apparatus 10 comprises a flying object 20 and an imaging apparatus 60. The flying object 20 is, for example, an unmanned aerial vehicle such as a drone. The flight function of the flight imaging apparatus 10 is realized by the flying object 20. The flying object 20 includes a plurality of propellers 42, and causes the plurality of propellers 42 to rotate to fly. The flying of the flying object 20 is synonymous with the flying of the flight imaging apparatus 10. The flying object 20 is an example of “moving object” according to the technology of the present disclosure.

The imaging apparatus 60 is, for example, a digital camera or a video camera. The imaging function of the flight imaging apparatus 10 is realized by the imaging apparatus 60. The imaging apparatus 60 is mounted on the flying object 20. As an example, the imaging apparatus 60 is provided below the flying object 20. The imaging apparatus 60 is an example of “imaging apparatus” according to the technology of the present disclosure.

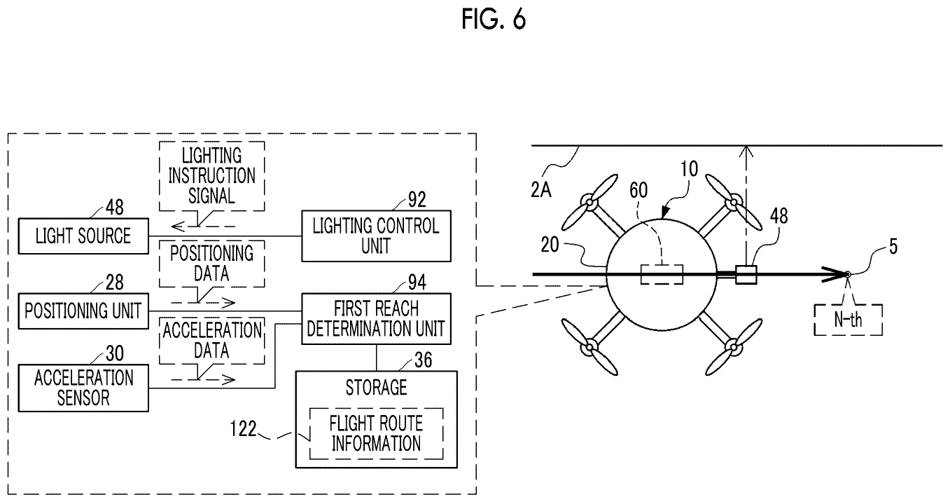

A plurality of flight routes 4 are set for the object 2. In the example shown in FIG. 1, the plurality of flight routes 4 are set on a virtual surface facing the wall surface 2A. The plurality of flight routes 4 are disposed side by side in a vertical direction, and each flight route 4 extends in a horizontal direction. The flight imaging apparatus 10 stores flight route information 122 (refer to FIG. 6) indicating each flight route 4 as described below, and can autonomously fly along each flight route 4 without depending on a flight instruction signal from a transmitter (not shown), a base station (not shown), or the like.

The flight imaging apparatus 10 sequentially flies along the plurality of flight routes 4. The flight imaging apparatus 10 flies along each flight route 4 to move in the horizontal direction. The plurality of flight routes 4 are flight routes along which the flight imaging apparatus 10 is caused to fly in the same direction. In the example shown in FIG. 1, each flight route 4 is a flight route along which the flight imaging apparatus 10 is caused to fly from left to right toward the wall surface 2A. A plurality of imaging positions 5 are set on each flight route 4. The flight imaging apparatus 10 images the wall surface 2A at each imaging position 5.

Here, an example is exemplified in which the flight imaging apparatus 10 autonomously flies along each flight route 4. However, the flight imaging apparatus 10 may fly along each flight route 4 based on the flight instruction signal from a transmitter, a base station, or the like.

With the imaging of the wall surface 2A at each imaging position 5, the flight imaging apparatus 10 sequentially images a plurality of imaging target regions 3 in the wall surface 2A. Each imaging target region 3 corresponds to each imaging position 5. The imaging target region 3 is a region determined by an angle of view of the flight imaging apparatus 10. The example shown in FIG. 1 shows a quadrangular region as an example of the imaging target region 3. The flight imaging apparatus 10 images the wall surface 2A at each imaging position 5 while sequentially flying along the plurality of flight routes 4, and thus the plurality of imaging target regions 3 disposed side by side in the horizontal direction and the vertical direction are imaged. The plurality of imaging target regions 3 are imaged in an aspect in which a part of the imaging target regions 3 adjacent to each other in the horizontal direction or the vertical direction overlaps each other.

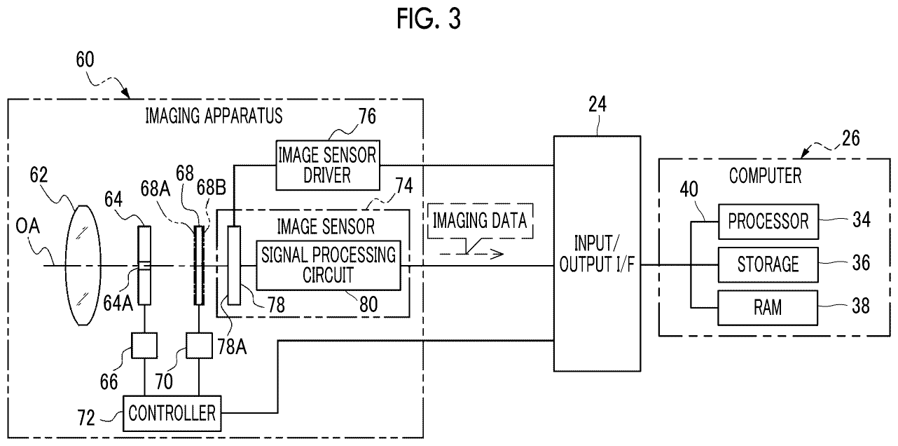

The example shown in FIG. 1 shows an aspect in which the imaging apparatus 60 images each imaging target region 3 in a state where an optical axis OA (refer to FIG. 3) of the imaging apparatus 60 is perpendicular to the wall surface 2A. Hereinafter, an example will be described in which the imaging apparatus 60 images each imaging target region 3 in a state where the optical axis OA of the imaging apparatus 60 is perpendicular to the wall surface 2A. Further, hereinafter, for convenience, the description will be made on the premise that a distance between the wall surface 2A and the imaging apparatus 60 is constant.

With the sequential imaging of the plurality of imaging target regions 3 by the imaging apparatus 60, a plurality of images for composition 142 are obtained. The plurality of images for composition 142 are composited to generate a composite image 140. The plurality of images for composition 142 are composited such that a part of the images for composition 142 adjacent to each other in the horizontal direction or the vertical direction overlaps each other. Hereinafter, each of the partial overlapping of the imaging target regions 3 adjacent to each other and the partial overlapping of the images for composition 142 adjacent to each other may be referred to as “overlap”.

An example of the composite image 140 includes a two-dimensional panoramic image. The two-dimensional panoramic image is merely an example, and a three-dimensional image (for example, three-dimensional panoramic image) may be generated as the composite image 140 in the same manner as the two-dimensional panoramic image is generated as the composite image 140. The composite image 140 is used, for example, for inspection and/or survey of the wall surface 2A of the object 2.

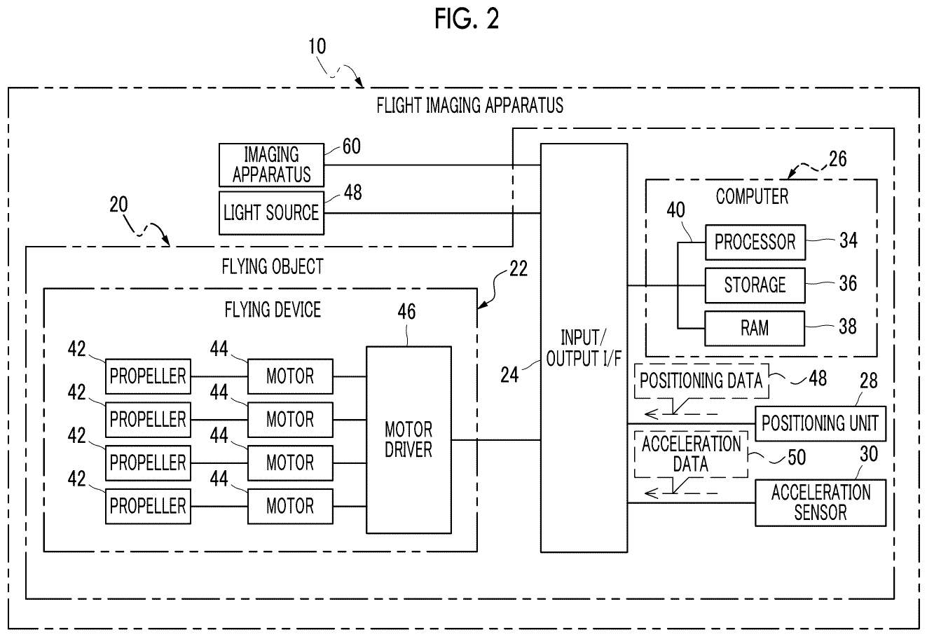

As shown in FIG. 2 as an example, the flying object 20 comprises a flying device 22, an input/output I/F 24, a computer 26, a positioning unit 28, and an acceleration sensor 30. The computer 26 is an example of “control device” and “computer” according to the technology of the present disclosure.

The computer 26 comprises a processor 34, a storage 36, and a RAM 38. The processor 34, the storage 36, and the RAM 38 are connected to each other via a bus 40, and the bus 40 is connected to the input/output I/F 24.

The processor 34 includes, for example, a CPU, and controls the entire flight imaging apparatus 10. Here, an example is exemplified in which the processor 34 includes the CPU, but this is merely an example. For example, the processor 34 may include the CPU and a GPU. In this case, for example, the GPU operates under control of the CPU, and is responsible for executing image processing. The processor 34 is an example of “processor” according to the present disclosed technology.

The storage 36 is a nonvolatile storage device that stores various programs, various parameters, and the like. Examples of the storage 36 include an HDD and an SSD. The HDD and the SSD are merely examples. Instead of the HDD and/or the SSD or together with the HDD and/or the SSD, a flash memory, a magnetoresistive memory, and/or a ferroelectric memory may be used.

The RAM 38 is a memory where information is temporarily stored, and is used as a work memory by the processor 34. Examples of the RAM 38 include a DRAM and/or an SRAM.

The flying device 22 includes the plurality of propellers 42, a plurality of motors 44, and a motor driver 46. The motor driver 46 is connected to the processor 34 via the input/output I/F 24 and the bus 40. The motor driver 46 individually controls the plurality of motors 44 in accordance with an instruction from the processor 34. The number of the plurality of motors 44 is the same as the number of the plurality of propellers 42.

The propeller 42 is fixed to a rotating shaft of each motor 44. Each motor 44 causes the propeller 42 to rotate. With the rotation of the plurality of propellers 42, the flying object 20 flies. The number of the plurality of propellers 42 (in other words, the number of the plurality of motors 44) provided in the flying object 20 is four as an example, but this is merely an example. For example, the number of the plurality of propellers 42 may be three, or five or more.

The positioning unit 28 is a device that detects a position of the flying object 20. The position of the flying object 20 is detected using, for example, GNSS (for example, GPS). The positioning unit 28 includes a GNSS receiver (not shown). The GNSS receiver receives, for example, radio waves transmitted from a plurality of satellites. The positioning unit 28 detects the position of the flying object 20 based on the radio wave received by the GNSS receiver, and outputs positioning data (for example, data indicating latitude, longitude, and altitude) according to the detected position.

The acceleration sensor 30 detects an acceleration of the flying object 20 in each axial direction of a pitch axis, a yaw axis, and a roll axis. The acceleration sensor 30 outputs acceleration data according to the acceleration of the flying object 20 in each axial direction. The processor 34 acquires the position of the flying object 20 based on the positioning data and/or the acceleration data.

In a case where the processor 34 acquires the position of the flying object 20 based on only the positioning data, the acceleration sensor 30 may be omitted. On the other hand, in a case where the processor 34 acquires the position of the flying object 20 based on only the acceleration data, the positioning unit 28 may be omitted.

In a case where the processor 34 acquires the position of the flying object 20 based on the positioning data, a position thereof in an absolute coordinate system is derived based on the positioning data. On the other hand, in a case where the processor 34 acquires an imaging position 5 based on the acceleration data, an amount of change in the position with respect to a reference position determined in a relative coordinate system is derived based on the acceleration data.

Further, the flying object 20 may comprise another device that detects the position of the flying object 20, instead of the positioning unit 28 and/or the acceleration sensor 30 or in addition to the positioning unit 28 and/or the acceleration sensor 30. Examples of another device include a LiDAR scanner, a stereo camera, a magnetic compass, an atmospheric pressure altimeter, and an ultrasonic sensor.

Further, the flight imaging apparatus 10 has an illumination function. The illumination function of the flight imaging apparatus 10 is to irradiate the wall surface 2A (refer to FIG. 1) with light. The flight imaging apparatus 10 comprises a light source 48, and the illumination function of the flight imaging apparatus 10 is realized by the light source 48. The light source 48 is, for example, an LED light source, a laser light source, a strobe light source, or an incandescent light bulb. The light source 48 is an example of “light source” according to the technique of the present disclosure.

As shown in FIG. 3 as an example, the imaging apparatus 60 comprises an imaging lens 62, a stop 64, a stop actuator 66, a shutter 68, a shutter actuator 70, a controller 72, an image sensor 74, and an image sensor driver 76.

The controller 72 and the image sensor driver 76 are connected to the processor 34 via the input/output I/F 24 and the bus 40. The imaging lens 62 includes, for example, an objective lens (not shown) and a focus lens (not shown). Further, the imaging apparatus 60 includes a zoom lens (not shown). The imaging lens 62 is disposed on an object side with respect to the stop 64, and the zoom lens is disposed between the stop 64 and the shutter 68.

The stop actuator 66 has a power transmission mechanism (not shown) and a motor for stop (not shown). The stop 64 has an opening 64A, and a size of the opening 64A is variable. The opening 64A is formed by a plurality of blades (not shown). The plurality of blades are linked to the power transmission mechanism. The motor for stop is connected to the power transmission mechanism, and the power transmission mechanism transmits power of the motor for stop to the plurality of blades. The plurality of blades operate by receiving the power transmitted from the power transmission mechanism to change the size of the opening 64A. The stop 64 changes the size of the opening 64A to adjust an exposure. The stop actuator 66 is connected to the controller 72.

The controller 72 is a device having, for example, a computer including a CPU, an NVM, and a RAM, although not shown. Here, the computer is illustrated, but this is merely an example. A device including an ASIC, an FPGA, and/or a PLD may be employed. Further, for example, a device implemented by a combination of a hardware configuration and a software configuration may be used as the controller 72. The controller 72 controls the stop actuator 66 in accordance with the instruction from the processor 34.

The image sensor 74 comprises a photoelectric conversion element 78 and a signal processing circuit 80. The image sensor 74 is a CMOS image sensor as an example. Here, the CMOS image sensor is illustrated as the image sensor 74, but the technology of the present disclosure is not limited thereto. For example, the technology of the present disclosure is also established in a case where the image sensor 74 is an image sensor of another type such as a CCD image sensor. The photoelectric conversion element 78 is connected to the image sensor driver 76. The image sensor driver 76 controls the photoelectric conversion element 78 in accordance with the instruction from the processor 34.

The photoelectric conversion element 78 has a light-receiving surface 78A on which a plurality of pixels (not shown) are provided. The photoelectric conversion element 78 outputs electric signals output from the plurality of physical pixels to the signal processing circuit 80 as imaging data. The signal processing circuit 80 converts the analog imaging data input from the photoelectric conversion element 78 into a digital form. The signal processing circuit 80 is connected to the input/output I/F 24. The processor 34 performs various types of processing on the digitized imaging data.

The shutter 68 is a focal plane shutter as an example, and is disposed between the stop 64 and the light-receiving surface 78A. The shutter 68 comprises a front curtain 68A and a rear curtain 68B. As an example, each of the front curtain 68A and the rear curtain 68B comprises a plurality of blades (not shown). The front curtain 68A is disposed closer to a subject side than the rear curtain 68B.

The shutter actuator 70 has a link mechanism (not shown), a solenoid for front curtain (not shown), and a solenoid for rear curtain (not shown). The solenoid for front curtain is a drive source for the front curtain 68A, and is mechanically linked to the front curtain 68A via the link mechanism. The solenoid for rear curtain is a drive source for the rear curtain 68B, and is mechanically linked to the rear curtain 68B via the link mechanism. The shutter actuator 70 is connected to the controller 72. The controller 72 controls the shutter actuator 70 in accordance with the instruction from the processor 34.

The solenoid for front curtain generates the power under the control of the controller 72, and applies the generated power to the front curtain 68A to selectively perform winding-up and pulling-down of the front curtain 68A. The solenoid for rear curtain generates the power under the control of the controller 72, and applies the generated power to the rear curtain 68B to selectively perform the winding-up and the pulling-down of the rear curtain 68B. In the imaging apparatus 60, opening and closing of the front curtain 68A and opening and closing of the rear curtain 68B are controlled by the processor 34 to adjust an exposure amount with respect to the image sensor 74. Further, a shutter speed of the shutter 68 is defined by a time period during which the front curtain 68A and the rear curtain 68B are open.

Although the focal plane shutter has been described as an example of the shutter 68 here, this is merely an example, and the shutter 68 may be a lens shutter. Further, an example has been described in which the shutter speed of the shutter 68 is defined, but this is merely an example. For example, a shutter speed of an electronic shutter (for example, electronic front curtain shutter or fully electronic shutter) may be defined.

Further, in the examples shown in FIGS. 2 and 3, the computer 26 common to the flying object 20 and the imaging apparatus 60 is used. However, the computer 26 may be configured by a first computer provided in the flying object 20 and a second computer provided in the imaging apparatus 60. Further, the computer 26 is mounted on the flying object 20, but may be mounted on the imaging apparatus 60 or may be mounted on a transmitter or a base station.

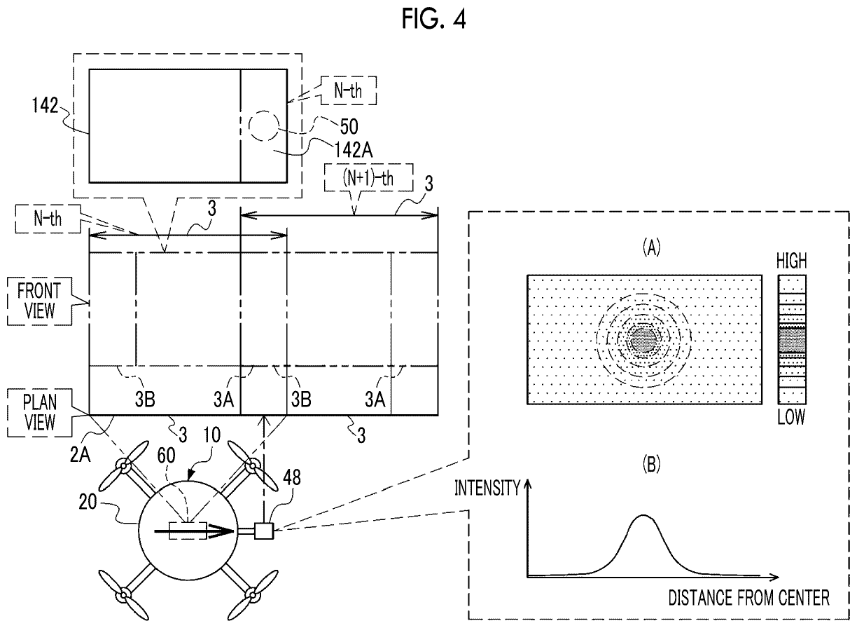

FIG. 4 shows an example of an aspect in which an N-th imaging target region 3 and an (N+1)-th imaging target region 3 are imaged according to a flying position of the flight imaging apparatus 10. Nis a number indicating the order in which the imaging target regions are imaged, and is a natural number. The N-th imaging target region 3 and the (N+1)-th imaging target region 3 are regions in which the N-th imaging target region 3 and the (N+1)-th imaging target region 3 are imaged in this order. The N-th imaging target region 3 and the (N+1)-th imaging target region 3 are regions disposed side by side in the horizontal direction.

Each imaging target region 3 has a first region 3A and a second region 3B. The first region 3A and the second region 3B are partial regions of the imaging target region 3. The first region 3A is located on a front side of the flying object 20 in a flying direction in the imaging target region 3, and the second region 3B is located on a rear side of the flying object 20 in the flying direction in the imaging target region 3. The first region 3A of the N-th imaging target region 3 overlaps with the second region 3B of the (N+1)-th imaging target region 3.

In the first embodiment, the N-th imaging target region 3 is an example of “first imaging target region” according to the technology of the present disclosure. The (N+1)-th imaging target region 3 is an example of “second imaging target region” according to the technology of the present disclosure. The first region 3A of the N-th imaging target region 3 is an example of “first region” according to the technology of the present disclosure. The second region 3B of the (N+1)-th imaging target region 3 is an example of “second region” according to the technology of the present disclosure.

The light source 48 is disposed on the front side of the flying object 20 in the flying direction with respect to the imaging apparatus 60. The light source 48 irradiates each imaging target region 3 with light. The light source 48 is disposed at a position where an optical axis passes through each first region 3A (center of each first region 3A as an example) in a case where the imaging apparatus 60 images each imaging target region 3. In other words, the light source 48 is disposed at a position where each imaging target region 3 is irradiated with light along a normal direction of each first region 3A in a case where the imaging apparatus 60 images each imaging target region 3. The normal direction may be an average normal direction of the first region 3A.

As an example, an alignment characteristic of the light source 48 is shown in FIG. 4. (A) of FIG. 4 shows a light intensity distribution, and (B) of FIG. 4 shows a relationship between a light intensity and a distance from a light center. As indicated by the alignment characteristic, the light from the light source 48 has a characteristic in which the intensity decreases as the distance from the center increases. Since the light source 48 has such an alignment characteristic, the intensity of light with which the first region 3A is irradiated is higher than the intensity of light with which a periphery of the first region 3A is irradiated.

Further, for example, in a case where an N-th image for composition 142 is obtained by imaging the N-th imaging target region 3, a size of the light source 48 is set to a size in which an image 50 (that is, image of reflected light) of the light source 48 fits in an image region 142A corresponding to the first region 3A in the N-th image for composition 142. Hereinafter, the image 50 of the light source 48 is referred to as “light source image 50”.

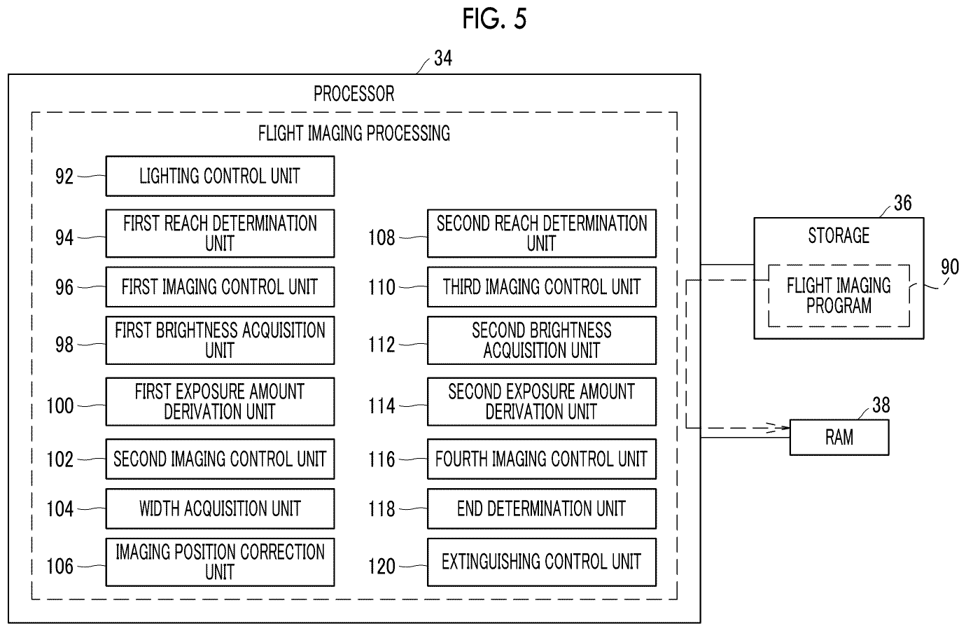

As shown in FIG. 5 as an example, the storage 36 stores a flight imaging program 90. The flight imaging program 90 is an example of “program” according to the present disclosed technology. The processor 34 reads out the flight imaging program 90 from the storage 36, and executes the readout flight imaging program 90 on the RAM 38. The processor 34 performs flight imaging processing of imaging each imaging target region 3 while flying along each flight route 4, in accordance with the flight imaging program 90 executed on the RAM 38.

The flight imaging processing is realized by the processor 34 operating as a lighting control unit 92, a first reach determination unit 94, a first imaging control unit 96, a first brightness acquisition unit 98, a first exposure amount derivation unit 100, a second imaging control unit 102, a width acquisition unit 104, an imaging position correction unit 106, a second reach determination unit 108, a third imaging control unit 110, a second brightness acquisition unit 112, a second exposure amount derivation unit 114, a fourth imaging control unit 116, an end determination unit 118, and an extinguishing control unit 120, in accordance with the flight imaging program 90. The flight imaging processing is executed in a case where the flight imaging apparatus 10 starts flying from a start end of each flight route 4.

As shown in FIG. 6 as an example, the lighting control unit 92 outputs a lighting instruction signal to the light source 48 to cause the light source 48 to light. Accordingly, the wall surface 2A is irradiated with light. The lighting control unit 92 causes the light source 48 to perform the light irradiation until the flying object 20 reaches an N-th imaging position 5. The N-th imaging position 5 shown in FIG. 6 is a first imaging position 5 as an example. In the first embodiment, the intensity of the light emitted from the light source 48 is constant. The control by the lighting control unit 92 is an example of “control of causing the light source to irradiate the first imaging target region with light” and “control of causing the light source to perform the light irradiation in a case where the moving object is moved to a position where the imaging apparatus images the first imaging target region” according to the technology of the present disclosure.

The storage 36 stores the flight route information 122 indicating the flight route 4. The flight route information 122 includes imaging position information indicating a position of each imaging position 5 set on the flight route 4.

The first reach determination unit 94 acquires the position of the flying object 20 based on the positioning data, which is input from the positioning unit 28, and/or the acceleration data, which is input from the acceleration sensor 30. The first reach determination unit 94 determines whether or not the flying object 20 has reached the N-th imaging position 5, based on the acquired position of the flying object 20 and the N-th imaging position 5 indicated by the flight route information 122.

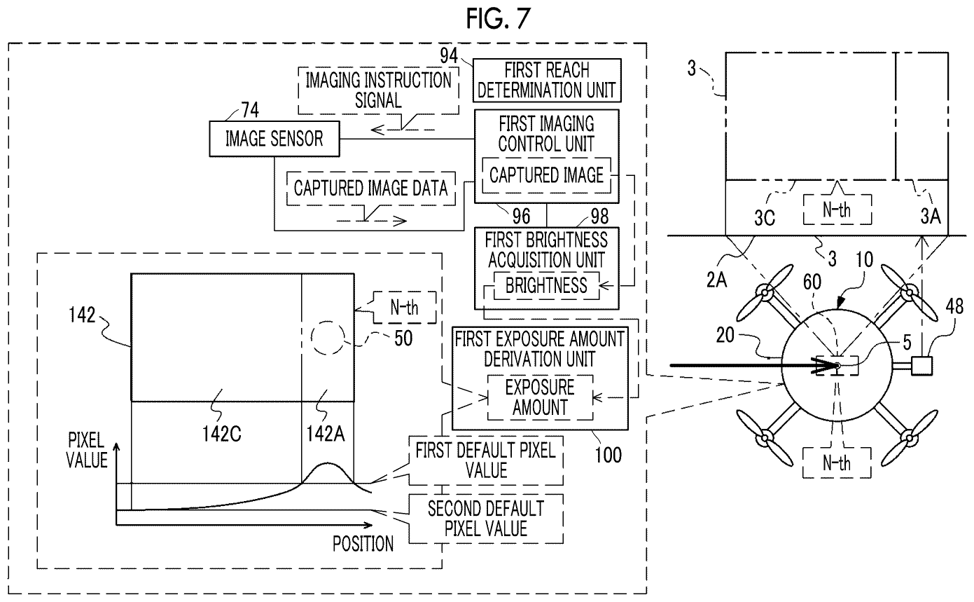

FIG. 7 shows an example of an aspect in which the flying object 20 has reached the N-th imaging position 5. In a case where the N-th imaging position 5 is reached, the flying object 20 is temporarily stationary. In a case where the flying object 20 has reached the N-th imaging position 5, the N-th imaging target region 3 is irradiated with light from the light source 48. In this case, the intensity of the light with which the first region 3A in the N-th imaging target region 3 is irradiated is higher than the intensity of the light with which the periphery of the first region 3A in the N-th imaging target region 3 is irradiated.

In a case where the first reach determination unit 94 determines that the flying object 20 has reached the N-th imaging position 5, the first imaging control unit 96 outputs an imaging instruction signal to the image sensor 74 to cause the image sensor 74 to image the N-th imaging target region 3. The image sensor 74 images the N-th imaging target region 3 under the control of the first imaging control unit 96, and thus captured image data is obtained. The captured image data indicates a captured image. The first imaging control unit 96 acquires the captured image corresponding to the N-th imaging target region 3 based on the captured image data. The captured image may be an image for brightness detection to detect brightness or an image for display such as a live view image displayed on a display device (not shown).

The first brightness acquisition unit 98 acquires the brightness of a third region 3C other than the first region 3A in the N-th imaging target region 3, based on the captured image acquired by the first imaging control unit 96. The first brightness acquisition unit 98 may acquire, as the brightness of the third region 3C, the brightness of a central region of the N-th imaging target region 3, may acquire the brightness of a central region of the third region 3C, or may acquire the brightness of the entire third region 3C. Further, the brightness may be a representative value (for example, maximum value, minimum value, or central value) or an average value. The third region 3C is an example of “third region” according to the technology of the present disclosure.

The first exposure amount derivation unit 100 derives the exposure amount, based on the brightness acquired by the first brightness acquisition unit 98. The exposure amount may be derived based on a table stored in the storage 36, or may be derived based on a relational expression stored in the storage 36.

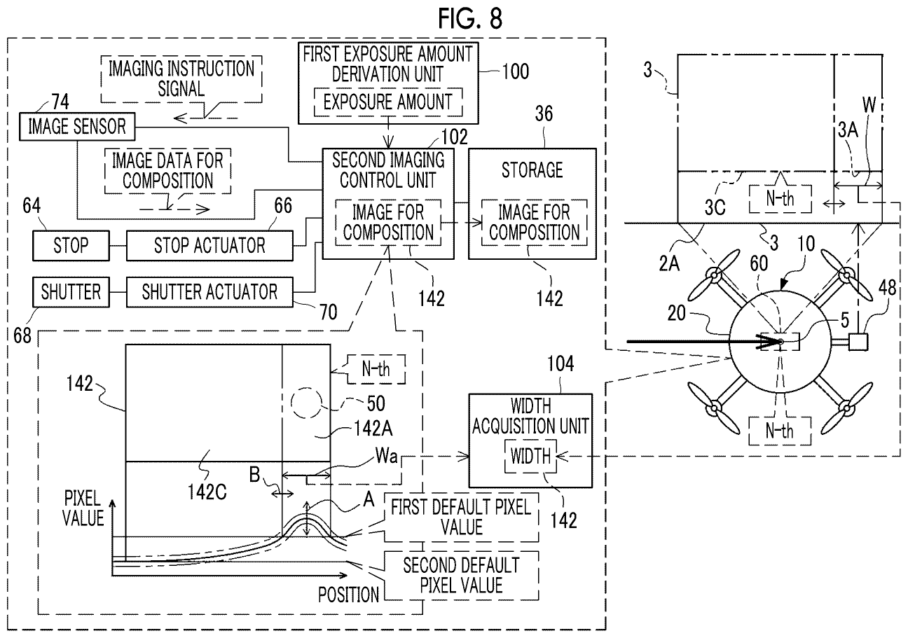

As an example, FIG. 7 shows a correspondence relationship between a graph showing a pixel value of the N-th image for composition 142 (refer to also FIG. 8) described below and the image for composition 142. The graph showing the pixel value of the N-th image for composition 142 has a shape corresponding to a graph (refer to FIG. 4) showing the alignment characteristic of the light source 48.

The exposure amount is set to, for example, the following exposure amount. That is, in a case where the N-th image for composition 142 is obtained as described below, the pixel value of the image region 142A corresponding to the first region 3A in the N-th image for composition 142 is set to the exposure amount equal to or larger than a first default pixel value. The first default pixel value is set to, for example, a pixel value at which the pixel value of the image region 142A is saturated. The first default pixel value may be set to a pixel value at which the pixel value of at least a part of the image region 142A is saturated.

Further, the exposure amount is set to an exposure amount at which the pixel value of an image region 142C corresponding to the third region 3C in the N-th image for composition 142 is equal to or larger than a second default pixel value and less than the first default pixel value. For example, in a case where the inspection and/or survey is performed based on the image region 142C corresponding to the third region 3C, the second default pixel value is set to a pixel value corresponding to brightness (that is, brightness suitable for the inspection and/or survey) at which the inspection and/or survey may be performed. The imaging target region 3 is irradiated with light having a light amount to such an extent that the pixel value of the image region 142A corresponding to the first region 3A is saturated, and thus the light amount of the light with which the third region 3C adjacent to the first region 3A is irradiated is ensured.

FIG. 8 shows an example of an aspect in which the flying object 20 is temporarily stationary at the N-th imaging position 5. The second imaging control unit 102 outputs the imaging instruction signal to the image sensor 74 to cause the image sensor 74 to image the N-th imaging target region 3. Further, in a case where the image sensor 74 is caused to image the N-th imaging target region 3, the second imaging control unit 102 adjusts the exposure amount of the light-receiving surface 78A (refer to FIG. 3) of the image sensor 74 to the exposure amount derived by the first exposure amount derivation unit 100.

The exposure amount is adjusted, for example, by changing the exposure to the light-receiving surface 78A. Specifically, the second imaging control unit 102 controls the stop actuator 66 to perform control of changing the size of the stop 64 and/or controls the shutter actuator 70 to perform control of changing the shutter speed of the shutter 68, and thus the exposure to the light-receiving surface 78A is changed.

Here, an example is exemplified in which the control of changing the size of the stop 64 by the second imaging control unit 102 and the control of changing the shutter speed of the shutter 68 by the second imaging control unit 102 (hereinafter referred to as “two types of control”) are performed. However, any one of the two types of control may be omitted.

The image sensor 74 images the N-th imaging target region 3 under the control of the second imaging control unit 102, and thus an N-th image data for composition is obtained. The image data for composition indicates the image for composition 142. The second imaging control unit 102 acquires the N-th image for composition 142 corresponding to the N-th imaging target region 3, based on the image data for composition.

The image region 142A corresponding to the first region 3A in the N-th image for composition 142 includes the light source image 50. The storage 36 stores the N-th image for composition 142. In a case where the N-th image for composition 142 is acquired, the flying object 20 restarts the movement in the horizontal direction.

For example, the pixel value of the image region 142A may fluctuate, as indicated by an arrow A, due to a variation in at least any of a distance between the wall surface 2A and the flight imaging apparatus 10, a reflectivity of the light with which the N-th imaging target region 3 is irradiated, or the exposure amount. In a case where the pixel value of the image region 142A fluctuates, a width Wa of the image region 142A (in other words, a position of a boundary between the image region 142A and the image region 142C) fluctuates as indicated by an arrow B.

The width acquisition unit 104 specifies the width Wa of the image region 142A (that is, a width of a region in which the pixel value is equal to or larger than the first default pixel value), based on the pixel value of the image region 142A in the N-th image for composition 142 acquired by the second imaging control unit 102. The width acquisition unit 104 derives a width W of the first region 3A corresponding to the width Wa of the image region 142A, based on the width Wa of the image region 142A to acquire the width W of the first region 3A. The width W of the first region 3A corresponds to a length of the first region 3A along the flying direction of the flying object 20. The flying direction is an example of “movement direction” according to the technology of the present disclosure, and the width W of the first region 3A is an example of “length of the first region” according to the technology of the present disclosure.

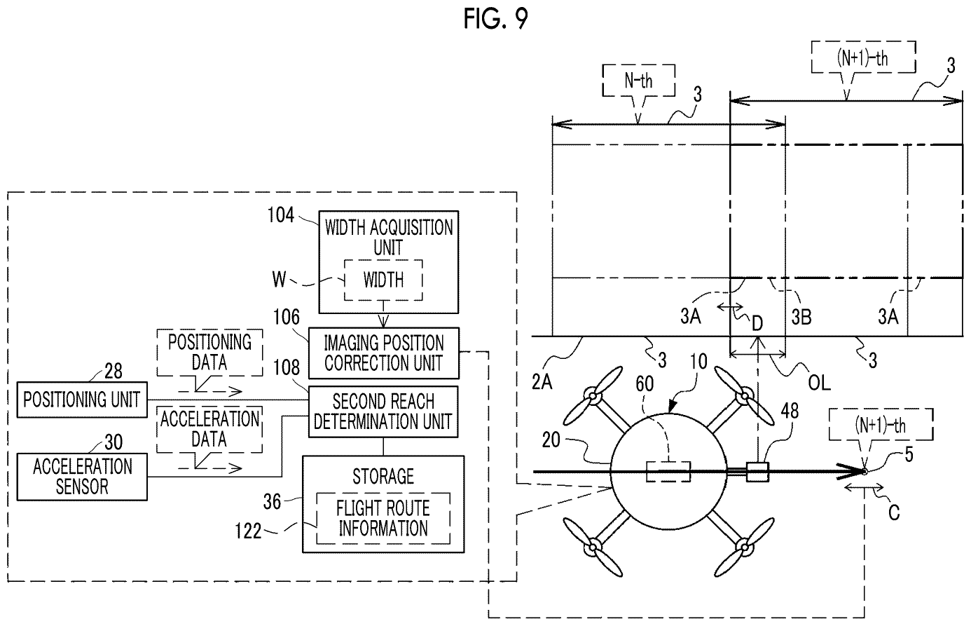

FIG. 9 shows an example of an aspect before the flying object 20 reaches an (N+1)-th imaging position 5. The (N+1)-th imaging position 5 shown in FIG. 9 is a second imaging position 5 as an example. The imaging position correction unit 106 corrects a position of the (N+1)-th imaging position 5 corresponding to the (N+1)-th imaging target region 3, as indicated by an arrow C, based on the width W of the first region 3A acquired by the width acquisition unit 104. In a case where the position of the imaging position 5 is corrected, a position of the (N+1)-th imaging target region 3 is corrected as indicated by an arrow D.

Specifically, the imaging position correction unit 106 corrects the position of the (N+1)-th imaging position 5 to a position where the first region 3A (that is, first region 3A having the width acquired by the width acquisition unit 104) of the N-th imaging target region 3 and the second region 3B of the (N+1)-th imaging target region 3 overlap each other. In a state where the first region 3A and the second region 3B overlap each other, the second region 3B has the same width as the first region 3A. With the change of the widths of the first region 3A and the second region 3B in this manner, an overlap amount OL of the first region 3A and the second region 3B is changed.

The second reach determination unit 108 acquires the position of the flying object 20 based on the positioning data, which is input from the positioning unit 28, and/or the acceleration data, which is input from the acceleration sensor 30. The second reach determination unit 108 determines whether or not the flying object 20 has reached the (N+1)-th imaging position 5, based on the acquired position of the flying object 20 and the (N+1)-th imaging position 5 corrected by the imaging position correction unit 106.

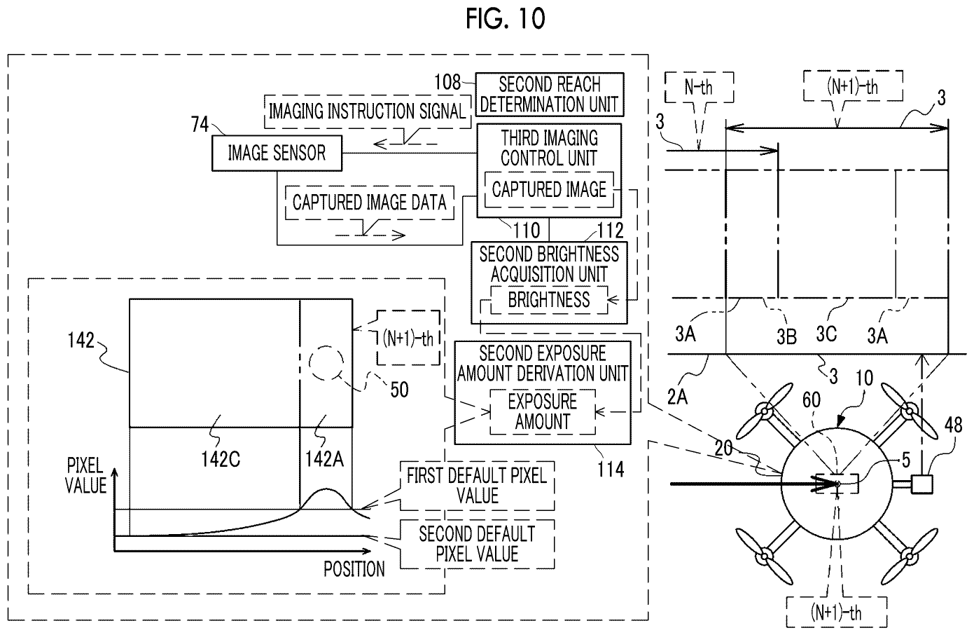

FIG. 10 shows an example of an aspect in which the flying object 20 has reached the (N+1)-th imaging position 5. In a case where the (N+1)-th imaging position 5 is reached, the flying object 20 is temporarily stationary. In a case where the flying object 20 has reached the (N+1)-th imaging position 5, the (N+1)-th imaging target region 3 is irradiated with light from the light source 48. In this case, the intensity of the light with which the first region 3A in the (N+1)-th imaging target region 3 is irradiated is higher than the intensity of the light with which the periphery of the first region 3A in the (N+1)-th imaging target region 3 is irradiated. The first region 3A of the (N+1)-th imaging target region 3 is an example of “fourth region” according to the technology of the present disclosure.

In a case where the reach determination unit determines that the flying object 20 has reached the (N+1)-th imaging position 5, the third imaging control unit 110 outputs the imaging instruction signal to the image sensor 74 to cause the image sensor 74 to image the (N+1)-th imaging target region 3. The image sensor 74 images the (N+1)-th imaging target region 3 under the control of the third imaging control unit 110, and thus the captured image data is obtained. The third imaging control unit 110 acquires the captured image corresponding to the (N+1)-th imaging target region 3, based on the captured image data.

The second brightness acquisition unit 112 acquires the brightness of the third region 3C other than the first region 3A of the (N+1)-th imaging target region 3, based on the captured image acquired by the third imaging control unit 110. The second brightness acquisition unit 112 may acquire, as the brightness of the third region 3C, the brightness of a central region of the (N+1)-th imaging target region 3, may acquire the brightness of the central region of the third region 3C, or may acquire the brightness of the entire third region 3C. Further, the brightness may be a representative value (for example, maximum value, minimum value, or central value) or an average value.

The second exposure amount derivation unit 114 derives the exposure amount based on the brightness acquired by the second brightness acquisition unit 112. The exposure amount may be derived based on a table stored in the storage 36, or may be derived based on a relational expression stored in the storage 36.

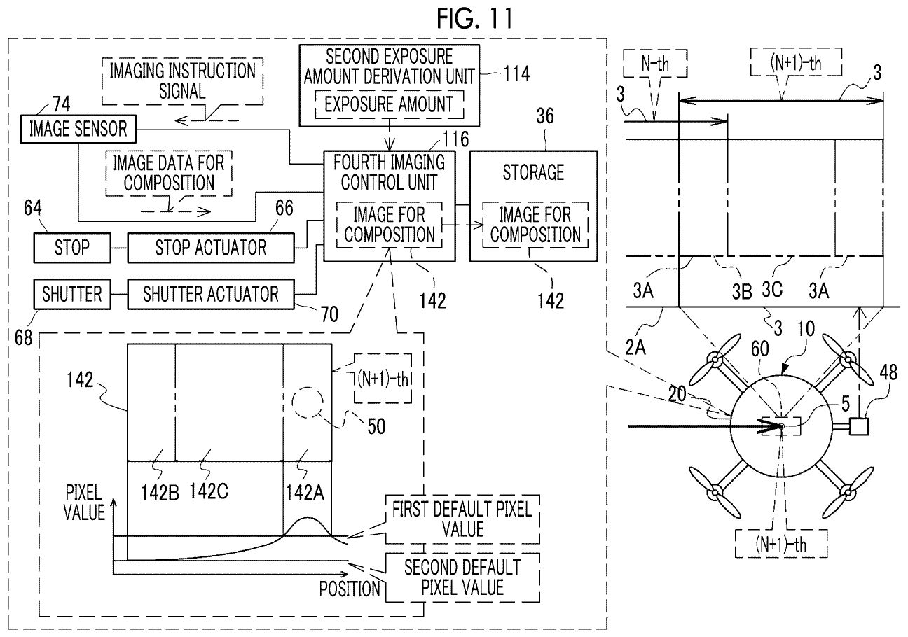

As an example, FIG. 10 shows a correspondence relationship between a graph showing a pixel value of an (N+1)-th image for composition 142 (refer to also FIG. 11) described below and the image for composition 142. The graph showing the pixel value of the (N+1)-th image for composition 142 has a shape corresponding to the graph (refer to FIG. 4) showing the alignment characteristic of the light source 48.

The exposure amount is set to, for example, the following exposure amount. That is, in a case where the (N+1)-th image for composition 142 is obtained as described below, the pixel value of the image region 142A corresponding to the first region 3A in the (N+1)-th image for composition 142 is set to the exposure amount equal to or larger than the first default pixel value. The first default pixel value is set to, for example, a pixel value at which the pixel value of the image region 142A is saturated. The first default pixel value may be set to the pixel value at which the pixel value of at least the part of the image region 142A is saturated.

Further, the exposure amount is set to an exposure amount at which the pixel value of the image region 142C corresponding to the third region 3C in the (N+1)-th image for composition 142 is equal to or larger than the second default pixel value and less than the first default pixel value. For example, in a case where the inspection and/or survey is performed based on the image region 142C corresponding to the third region 3C, the second default pixel value is set to a pixel value corresponding to brightness (that is, brightness suitable for the inspection and/or survey) at which the inspection and/or survey may be performed. The imaging target region 3 is irradiated with light having a light amount to such an extent that the pixel value of the image region 142A corresponding to the first region 3A is saturated, and thus the light amount of the light with which the third region 3C adjacent to the first region 3A is irradiated is ensured.

FIG. 11 shows an example of an aspect in which the flying object 20 is temporarily stationary at the (N+1)-th imaging position 5. The fourth imaging control unit 116 outputs the imaging instruction signal to the image sensor 74 to cause the image sensor 74 to image the (N+1)-th imaging target region 3. Further, in a case where the image sensor 74 is caused to image the (N+1)-th imaging target region 3, the fourth imaging control unit 116 adjusts the exposure amount of the light-receiving surface 78A (refer to FIG. 3) to the exposure amount derived by the second exposure amount derivation unit 114.

The exposure amount is adjusted, for example, by changing the exposure to the light-receiving surface 78A. Specifically, the fourth imaging control unit 116 controls the stop actuator 66 to perform control of changing the size of the stop 64 and/or controls the shutter actuator 70 to perform control of changing the shutter speed of the shutter 68, and thus the exposure to the light-receiving surface 78A is changed.

Here, an example is exemplified in which the control of changing the size of the stop 64 by the fourth imaging control unit 116 and the control of changing the shutter speed of the shutter 68 by the fourth imaging control unit 116 (hereinafter referred to as “two types of control”) are performed. However, any one of the two types of control may be omitted.

The image sensor 74 images the (N+1)-th imaging target region 3 under the control of the fourth imaging control unit 116, and thus (N+1)-th image data for composition is obtained. The fourth imaging control unit 116 acquires the (N+1)-th image for composition 142 corresponding to the (N+1)-th imaging target region 3, based on the image data for composition.

The light source image 50 is included in the image region 142A corresponding to the first region 3A in the (N+1)-th image for composition 142, and is not included in the image region 142C corresponding to the third region 3C other than the first region 3A in the (N+1)-th image for composition 142. The third region 3C other than the first region 3A includes the second region 3B, and the image region 142C other than the image region 142A includes an image region 142B corresponding to the second region 3B. The storage 36 stores the (N+1)-th image for composition 142. In a case where the (N+1)-th image for composition 142 is acquired, the flying object 20 resumes the movement in the horizontal direction.

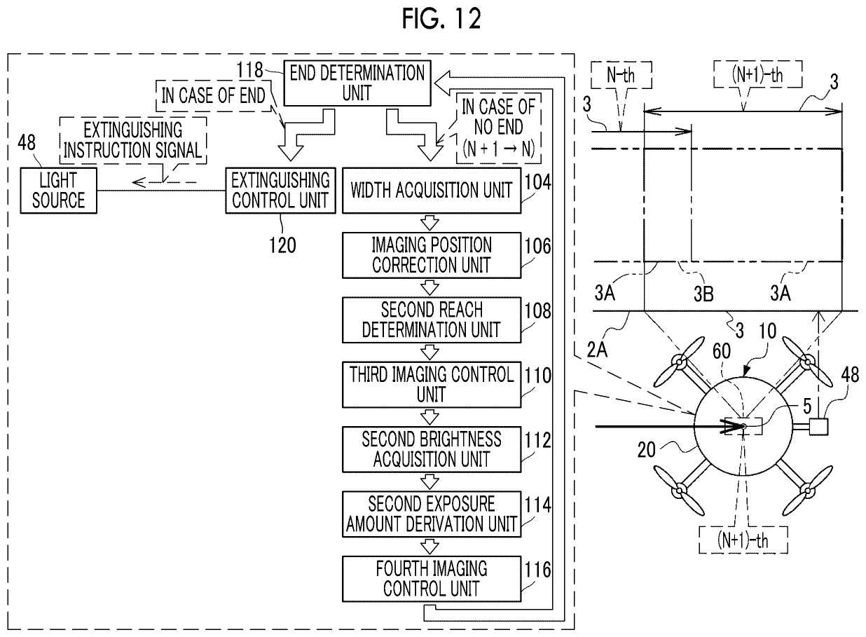

As shown in FIG. 12 as an example, the end determination unit 118 determines whether or not a condition (hereinafter referred to as “end condition”) for ending the flight imaging processing is satisfied. Examples of the end condition include a condition that the number of the plurality of images for composition 142 stored in the storage 36 reaches the number of the plurality of imaging positions 5 set on the flight route 4, and a condition that an instruction to end the flight imaging processing is assigned to the flight imaging apparatus 10 by the user or the like.

In a case where the end determination unit 118 determines that the end condition is not satisfied, the (N+1)-th image for composition 142 is treated as the N-th image for composition 142. In order to obtain a new (N+1)-th image for composition 142, the processing by the width acquisition unit 104 to the processing by the fourth imaging control unit 116 is executed again.

In a case where the end determination unit 118 determines that the end condition is satisfied, the extinguishing control unit 120 outputs an extinguishing instruction signal to the light source 48 to cause the light source 48 to be extinguished.

Here, an example is exemplified in which the flight imaging apparatus 10 executes the flight imaging processing. However, the flight imaging processing may be executed by a transmitter (not shown) or a base station (not shown) communicably connected to the flight imaging apparatus 10.

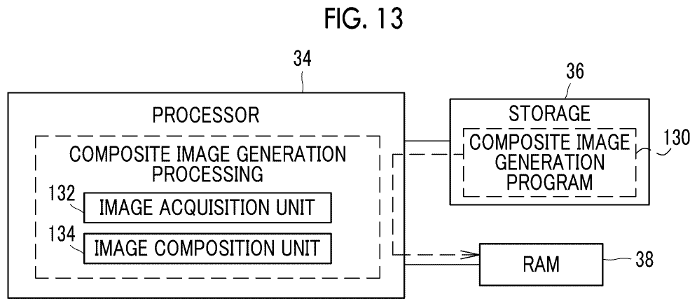

As shown in FIG. 13 as an example, the storage 36 stores a composite image generation program 130. The composite image generation program 130 is an example of “program” according to the technology of the present disclosure. The processor 34 reads out the composite image generation program 130 from the storage 36, and executes the readout composite image generation program 130 on the RAM 38. The processor 34 performs composite image generation processing of imaging each imaging target region 3 while flying each flight route 4, in accordance with the composite image generation program 130 executed on the RAM 38.

The composite image generation processing is realized by the processor 34 operating as an image acquisition unit 132 and an image composition unit 134, in accordance with the flight imaging program 90. The composite image generation processing may be executed each time each image for composition 142 is obtained from a second frame and subsequent frames, or may be executed after the plurality of images for composition 142 are obtained for the wall surface 2A. Hereinafter, the composite image generation processing will be described using a case where the N-th image for composition 142 and the (N+1)-th image for composition 142 are composited to generate the composite image 140.

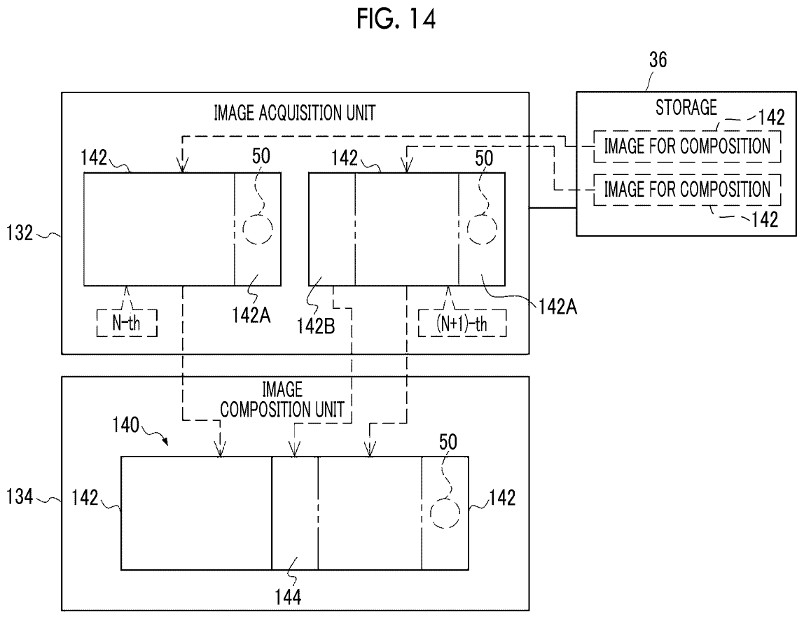

As shown in FIG. 14 as an example, the image acquisition unit 132 acquires the N-th image for composition 142 and the (N+1)-th image for composition 142, which are stored in the storage 36. The light source image 50 is included in the image region 142A in the N-th image for composition 142, and is not included in the image region 142B in the (N+1)-th image for composition 142.

The image composition unit 134 composites the N-th image for composition 142 and the (N+1)-th image for composition 142 to generate the composite image 140. In a case where the composite image 140 is generated, the image composition unit 134 uses the pixel value of the image region 142B in the (N+1)-th image for composition 142 as the pixel value of an overlap image region 144 in the composite image 140. Accordingly, the composite image 140 in which the light source image 50 is not included in the overlap image region 144 is obtained. The overlap image region 144 is a region corresponding to the first region 3A and the second region 3B (refer to FIG. 12) that overlap each other.

Here, an example is exemplified in which the flight imaging apparatus 10 executes the composite image generation processing. However, the composite image generation processing may be executed by an external apparatus (not shown) that is communicably connected to the flight imaging apparatus 10.

Further, in a case where the composite image 140 is generated based on the plurality of images for composition 142, the light source image 50 is included in a last image for composition 142 included in the composite image 140. Therefore, for example, in a case where the composite image 140 is generated based on the images for composition 142 of three or more frames, the image region 142A in the last image for composition 142 included in the composite image 140 may be removed from the composite image 140. Further, the first region 3A of the last imaging target region 3 may be a region other than an inspection target region.

The N-th image for composition 142 is an example of “first captured image” according to the technology of the present disclosure. The (N+1)-th image for composition 142 is an example of “second captured image” according to the technology of the present disclosure. The composite image 140 is an example of “composite image” according to the technology of the present disclosure.

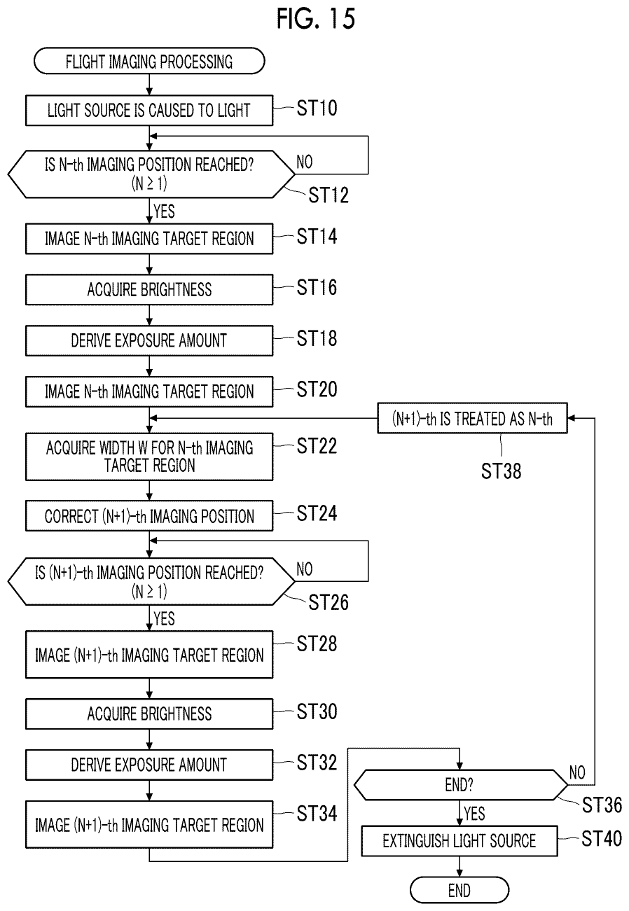

Next, an action of the flight imaging apparatus 10 according to the first embodiment will be described. First, the flight imaging processing will be described. FIG. 15 shows an example of a flow of the flight imaging processing according to the first embodiment.

In the flight imaging processing shown in FIG. 15, first, in step ST10, the lighting control unit 92 causes the light source 48 to light (refer to FIG. 6). Accordingly, the wall surface 2A is irradiated with light. After the processing of step ST10 is executed, the flight imaging processing transitions to step ST12.

In step ST12, the first reach determination unit 94 acquires the position of the flying object 20 based on the positioning data, which is input from the positioning unit 28, and/or the acceleration data, which is input from the acceleration sensor 30. The first reach determination unit 94 determines whether or not the flying object 20 has reached the N-th imaging position, 5 based on the acquired position of the flying object 20 and the N-th imaging position 5 indicated by the flight route information 122 (refer to FIG. 6). In step ST12, in a case where the flying object 20 has reached the N-th imaging position 5, the determination is positive, and the flight imaging processing transitions to step ST14. In step ST12, in a case where the flying object 20 has not reached the N-th imaging position 5, the determination is negative, and the flight imaging processing executes the processing of step ST12 again.

In step ST14, the first imaging control unit 96 causes the image sensor 74 to image the N-th imaging target region 3 (refer to FIG. 7). Accordingly, the captured image corresponding to the N-th imaging target region 3 is obtained. After the processing of step ST14 is executed, the flight imaging processing transitions to step ST16.

In step ST16, the first brightness acquisition unit 98 acquires the brightness of the third region 3C other than the first region 3A of the N-th imaging target region 3, based on the captured image acquired in step ST14 (refer to FIG. 7). After the processing of step ST16 is executed, the flight imaging processing transitions to step ST18.

In step ST18, the first exposure amount derivation unit 100 derives the exposure amount based on the brightness acquired in step ST16 (refer to FIG. 7). After the processing of step ST18 is executed, the flight imaging processing transitions to step ST20.

In step ST20, the second imaging control unit 102 causes the image sensor 74 to image the N-th imaging target region 3 (refer to FIG. 8). Further, in a case where the image sensor 74 is caused to image the N-th imaging target region 3, the second imaging control unit 102 controls the stop actuator 66 and/or the shutter actuator 70 to adjust the exposure amount of the light-receiving surface 78A to the exposure amount derived in step ST18. With the imaging of the N-th imaging target region 3 in a state where the exposure amount is adjusted, the image for composition 142 corresponding to the N-th imaging target region 3 is obtained. After the processing of step ST20 is executed, the flight imaging processing transitions to step ST22.

In step ST22, the width acquisition unit 104 specifies the width Wa of the image region 142A, based on the pixel value of the image region 142A corresponding to the first region 3A in the N-th image for composition 142 acquired in step ST20. The width acquisition unit 104 derives the width W of the first region 3A corresponding to the width Wa of the image region 142A, based on the width Wa of the image region 142A, to acquire the width W of the first region 3A (refer to FIG. 8). After the processing of step ST22 is executed, the flight imaging processing transitions to step ST24.

In step ST24, the imaging position correction unit 106 corrects the position of the imaging position 5 corresponding to the (N+1)-th imaging target region 3, based on the width W of the first region 3A acquired by the width acquisition unit 104 (refer to FIG. 9). After the processing of step ST24 is executed, the flight imaging processing transitions to step ST26.

In step ST26, the second reach determination unit 108 acquires the position of the flying object 20 based on the positioning data, which is input from the positioning unit 28, and/or the acceleration data, which is input from the acceleration sensor 30. The second reach determination unit 108 determines whether or not the flying object 20 has reached the (N+1)-th imaging position 5, based on the acquired position of the flying object 20 and the (N+1)-th imaging position 5 corrected in step ST24 (refer to FIG. 9). In step ST26, in a case where the flying object 20 has reached the (N+1)-th imaging position 5, the determination is positive, and the flight imaging processing transitions to step ST28. In step ST26, in a case where the flying object 20 has not reached the (N+1)-th imaging position 5, the determination is negative, and the flight imaging processing executes the processing of step ST26 again.

In step ST28, the third imaging control unit 110 causes the image sensor 74 to image the (N+1)-th imaging target region 3 (refer to FIG. 10). Accordingly, the captured image corresponding to the (N+1)-th imaging target region 3 is obtained. After the processing of step ST28 is executed, the flight imaging processing transitions to step ST30.

In step ST30, the second brightness acquisition unit 112 acquires the brightness of the third region 3C other than the first region 3A of the (N+1)-th imaging target region 3, based on the captured image acquired in step ST28 (refer to FIG. 10). After the processing of step ST30 is executed, the flight imaging processing transitions to step ST32.

In step ST32, the second exposure amount derivation unit 114 derives the exposure amount based on the brightness acquired in step ST30 (refer to FIG. 10). After the processing of step ST32 is executed, the flight imaging processing transitions to step ST34.

In step ST34, the fourth imaging control unit 116 causes the image sensor 74 to image the (N+1)-th imaging target region 3 (refer to FIG. 11). Further, in a case where the image sensor 74 is caused to image the (N+1)-th imaging target region 3, the fourth imaging control unit 116 controls the stop actuator 66 and/or the shutter actuator 70 to adjust the exposure amount of the light-receiving surface 78A to the exposure amount derived in step ST32. With the imaging of the (N+1)-th imaging target region 3 in a state where the exposure amount is adjusted, the image for composition 142 corresponding to the (N+1)-th imaging target region 3 is obtained. After the processing of step ST34 is executed, the flight imaging processing transitions to step ST36.

In step ST36, the end determination unit 118 determines whether or not the end condition for ending the flight imaging processing is satisfied (refer to FIG. 12). In step ST36, in a case where the end condition is not satisfied, the determination is negative, and the flight imaging processing transitions to step ST38. In step ST36, in a case where the end condition is satisfied, the determination is positive, and the flight imaging processing transitions to step ST40.

In step ST38, the processor 34 treats the (N+1)-th image for composition 142 as the N-th image for composition 142. After the processing of step ST38 is executed, the flight imaging processing transitions to step ST22.

In step ST40, the extinguishing control unit 120 causes the light source 48 to be extinguished (refer to FIG. 12). After the processing of step ST40 is executed, the flight imaging processing ends.

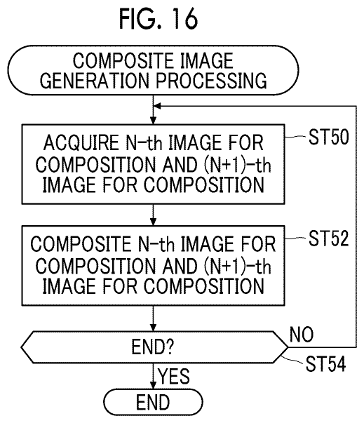

Subsequently, the composite image generation processing will be described. FIG. 16 shows an example of a flow of the composite image generation processing according to the first embodiment.

In the composite image generation processing shown in FIG. 16, first, in step ST50, the image acquisition unit 132 acquires the N-th image for composition 142 and the (N+1)-th image for composition 142, which are stored in the storage 36 (refer to FIG. 14). After the processing of step ST50 is executed, the composite image generation processing transitions to step ST52.

In step ST52, the image composition unit 134 composites the N-th image for composition 142 and the (N+1)-th image for composition 142 to generate the composite image 140 (refer to FIG. 14). In a case where the composite image 140 is generated, the image composition unit 134 uses the pixel value of the image region 142B in the (N+1)-th image for composition 142 as the pixel value of an overlap image region 144 in the composite image 140. Accordingly, the composite image 140 in which the light source image 50 is not included in the overlap image region 144 is obtained. After the processing of step ST52 is executed, the composite image generation processing transitions to step ST54.

In step ST54, the processor 34 determines whether or not a condition (hereinafter referred to as “end condition”) for ending the composite image generation processing is satisfied. Examples of the end condition include a condition that all of the plurality of images for composition 142 stored in the storage 36 are composited, and a condition that an instruction to end the composite image generation processing is assigned to the flight imaging apparatus 10 by the user or the like. In step ST54, in a case where the end condition is not satisfied, the determination is negative, and the composite image generation processing transitions to step ST50. In step ST54, in a case where the end condition is satisfied, the determination is positive, and the composite image generation processing ends. The control method described as the action of the flight imaging apparatus 10 is an example of “control method” according to the technology of the present disclosure.

Next, effects of the flight imaging apparatus 10 according to the first embodiment will be described.

In the first embodiment, the N-th image for composition 142 and the (N+1)-th image for composition 142 are composited to generate the composite image 140 (refer to FIG. 14). In a case where the composite image 140 is generated, the pixel value of the image region 142B in the (N+1)-th image for composition 142 is used as the pixel value of the overlap image region 144 in the composite image 140. Therefore, it is possible to avoid using the pixel value of the image region 142A (that is, the image region 142A including the light source image 50) in the N-th image for composition 142 as the pixel value of the overlap image region 144.

Further, the light source image 50 is included in the image region 142A in the N-th image for composition 142 (refer to FIG. 4). Therefore, with the avoidance of the use of the pixel value of the image region 142A in the N-th image for composition 142 as the pixel value of the overlap image region 144, it is possible to obtain the composite image 140 that does not include the light source image 50.

Further, the intensity of the light with which the first region 3A in the N-th imaging target region 3 is irradiated is higher than the intensity of the light with which the periphery of the first region 3A is irradiated (refer to FIG. 4). Therefore, it is possible to ensure the intensity of the light (that is, the intensity of light of the third region 3C) of the periphery of the first region 3A while increasing the intensity of the light of the first region 3 A corresponding to the image region 142A in the N-th image for composition 142. Accordingly, since the brightness of the third region 3C of the N-th imaging target region 3 can be ensured, it is possible to obtain an image that contributes to ensuring appropriate brightness of the entire composite image 140 as the N-th image for composition 142.

Further, in a case where the imaging apparatus 60 images the N-th imaging target region 3, the exposure amount of the light-receiving surface 78A is adjusted based on the brightness of the third region 3C of the N-th imaging target region 3 (refer to FIGS. 7 and 8). Therefore, with the adjustment of the exposure amount according to the brightness of the third region 3C, it is possible to ensure the brightness of the image region 142C corresponding to the third region 3C in the N-th image for composition 142.

Further, for example, with the control of changing the size of the stop 64 and/or the control of changing the shutter speed, the exposure to the light-receiving surface 78A is changed, and thus the exposure amount is adjusted (refer to FIG. 8). Therefore, it is possible to adjust the exposure amount by simple control, as compared with a case where special control other than the control of changing the size of the stop 64 and/or the control of changing the shutter speed is performed.

Further, the exposure amount is set to the exposure amount at which the pixel value of the image region 142A in the N-th image for composition 142 is equal to or larger than the first default pixel value (refer to FIG. 7). Therefore, with the avoidance of the use of the pixel value of the image region 142A in the N-th image for composition 142 as the pixel value of the overlap image region 144, it is possible to avoid the pixel value of the overlap image region 144 being equal to or larger than the first default pixel value.

Further, the first default pixel value is set to the pixel value at which the pixel value of at least a part of the image region 142A is saturated (refer to FIG. 7). Therefore, with the avoidance of the use of the pixel value of the image region 142A in the N-th image for composition 142 as the pixel value of the overlap image region 144, it is possible to avoid the generation of the composite image 140 in which the pixel value of at least the part of the image region 142A is saturated.

Further, the light having the intensity to such an extent that the pixel value of at least the part of the image region 142A is saturated is used. Accordingly, since an exposure time can be shortened as compared with a case where light having an intensity to such an extent that the pixel value is not saturated is used, it is possible to suppress the image shake.

Further, the exposure amount is set to the exposure amount at which the pixel value of the image region 142C in the N-th image for composition 142 is equal to or larger than the second default pixel value and less than the first default pixel value (refer to FIG. 7). Therefore, it is possible to ensure the brightness of the image region 142C in the N-th image for composition 142.

Further, the width Wa of the image region 142A is specified based on the pixel value of the image region 142A in the N-th image for composition 142, and the width W of the first region 3A corresponding to the width Wa of the image region 142A is derived based on the width Wa of the image region 142A (refer to FIG. 8). The position of the imaging position 5 corresponding to the (N+1)-th imaging target region 3 is corrected based on the width W of the first region 3A (refer to FIG. 9). Therefore, even in a case where the width W of the first region 3A corresponding to the width Wa of the image region 142A fluctuates as the pixel value of the image region 142A fluctuates, it is possible to change the overlap amount with which the first region 3A and the second region 3B overlap.

Further, the light source 48 is disposed on the front side of the flight imaging apparatus 10 in the flying direction with respect to the imaging apparatus 60 (refer to FIG. 4). Therefore, in a case where the N-th image for composition 142 and the (N+1)-th image for composition 142 are composited to generate the composite image 140, it is possible to avoid including the light source image 50 in the N-th image for composition 142.

Further, the light irradiation is performed along the normal direction of the first region 3A (refer to FIG. 4). Accordingly, it is possible to make the intensity of the light with which the first region 3A in the N-th imaging target region 3 is irradiated higher than the intensity of the light with which the periphery of the first region 3A is irradiated.

Further, the intensity of the light with which the first region 3A in the (N+1)-th imaging target region 3 is irradiated is higher than the intensity of the light with which the periphery of the first region 3A is irradiated (refer to FIG. 10). Accordingly, it is possible to ensure the intensity of the light (that is, the intensity of light of the third region 3C) of the periphery of the first region 3A while increasing the intensity of the light of the first region 3A corresponding to the image region 142A in the (N+1)-th image for composition 142. Accordingly, since the brightness of the third region 3C of the (N+1)-th imaging target region 3 can be ensured, it is possible to obtain an image that contributes to ensuring appropriate brightness of the entire composite image 140 as the (N+1)-th image for composition 142.

Further, the flight imaging apparatus 10 moves to each imaging position 5 in a state where the light source 48 is caused to perform the light irradiation. Therefore, it is not necessary to perform control of lighting and extinguishing the light source 48 each time the imaging position 5 is reached.

### Second Embodiment

Next, a second embodiment will be described.

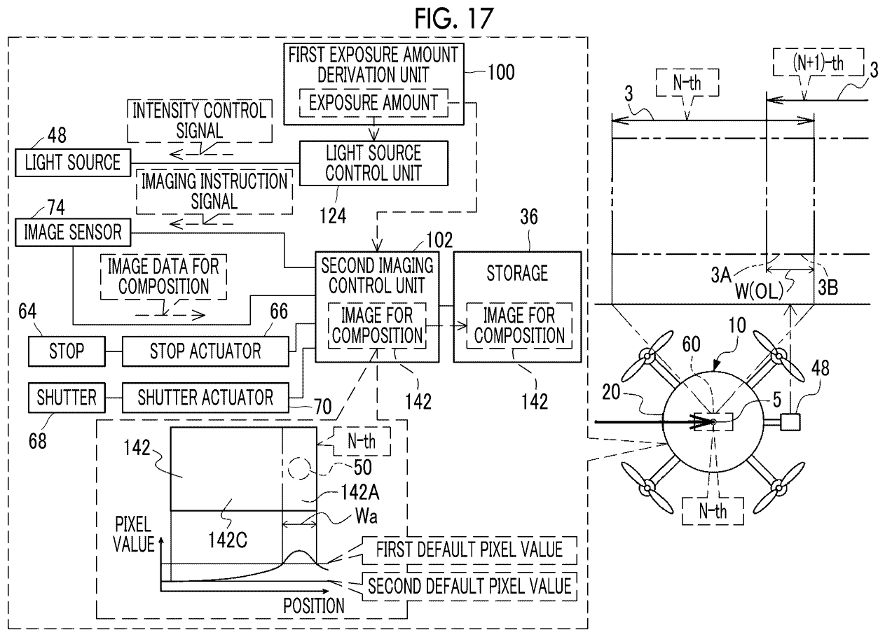

FIG. 17 shows an example of an aspect in which the flying object 20 has reached the N-th imaging position 5. In the second embodiment, the flight imaging processing is changed as follows, from the first embodiment. That is, in the second embodiment, the processing by the width acquisition unit 104 (refer to FIG. 8) and the processing by the imaging position correction unit 106 (refer to FIG. 9) are omitted. Further, in the second embodiment, the overlap amount OL of the first region 3A and the second region 3B is fixed to a default overlap amount.

The exposure amount derived by the first exposure amount derivation unit 100 is set to an exposure amount at which the width W of the first region 3A corresponding to the width Wa of the image region 142A (that is, the width of the region having the pixel value equal to or larger than the first default pixel value) in the N-th image for composition 142, which will be described below, matches the overlap amount OL.

In the second embodiment, the processor 34 (refer to FIG. 5) operates as a light source control unit 124. The light source control unit 124 controls the light source 48 to change the intensity of the light emitted from the light source 48. Specifically, the light source control unit 124 changes the light intensity, based on the exposure amount derived by the first exposure amount derivation unit 100.

The second imaging control unit 102 outputs the imaging instruction signal to the image sensor 74 to cause the image sensor 74 to image the N-th imaging target region 3. Further, in a case where the image sensor 74 is caused to image the N-th imaging target region 3, the second imaging control unit 102 adjusts the exposure amount of the light-receiving surface 78A (refer to FIG. 3) based on the exposure amount derived by the first exposure amount derivation unit 100.

The exposure amount is adjusted, for example, by changing the exposure to the light-receiving surface 78A. Specifically, the second imaging control unit 102 controls the stop actuator 66 to perform control of changing the size of the stop 64 and/or controls the shutter actuator 70 to perform control of changing the shutter speed of the shutter 68, and thus the exposure to the light-receiving surface 78A is changed.

With the control of changing the light intensity by the light source control unit 124, the control of changing the size of the stop 64 by the second imaging control unit 102, and the control of changing the shutter speed of the shutter 68 by the second imaging control unit 102 (hereinafter referred to as “three types of control”), the exposure amount of the light-receiving surface 78A is set to the exposure amount derived by the first exposure amount derivation unit 100.

According to the second embodiment, with the three types of control, the exposure amount of the light-receiving surface 78A is set to the exposure amount derived by the first exposure amount derivation unit 100. Accordingly, since the exposure amount of the light-receiving surface 78A is set to the exposure amount at which the width W of the first region 3A corresponding to the width Wa of the image region 142A (that is, the width of the region having the pixel value equal to or larger than the first default pixel value) in the N-th image for composition 142 matches the overlap amount OL, it is possible to fix the overlap amount OL to the default overlap amount.

Further, since the overlap amount OL is fixed to the default overlap amount, it is possible to improve the efficiency in a case where the plurality of imaging target regions 3 are imaged, as compared with a case where the overlap amount OL is changed to the overlap amount larger than the default overlap amount.

With any one or two types of control of the three types of control, the exposure amount of the light-receiving surface 78A may be set to the exposure amount derived by the first exposure amount derivation unit 100.

Further, the light source 48 may be configured to be capable of changing the irradiation position of the light, and the exposure amount may be adjusted by the change in the irradiation position of the light. Further, the light source 48 may be configured to be capable of changing the irradiation position of the light, and the exposure amount may be adjusted by the change in the irradiation position of the light and the light intensity. Even in this case, it is possible to set the exposure amount of the light-receiving surface 78A to the exposure amount derived by the first exposure amount derivation unit 100.

### Third Embodiment

Next, a third embodiment will be described.

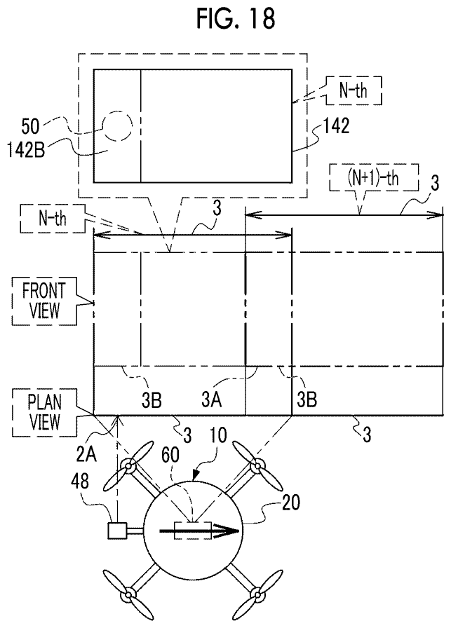

As shown in FIG. 18 as an example, the flight imaging apparatus 10 is changed as follows in the third embodiment, from the second embodiment. That is, the light source 48 is disposed on the rear side of the flying object 20 in the flying direction with respect to the imaging apparatus 60. The light source 48 irradiates each imaging target region 3 with light. The light source 48 is disposed at a position where the optical axis passes through each second region 3B (center of each second region 3B as an example) in a case where the imaging apparatus 60 images each imaging target region 3. In other words, the light source 48 is disposed at a position where each imaging target region 3 is irradiated with light along a normal direction of each second region 3B in a case where the imaging apparatus 60 images each imaging target region 3. The normal direction may be an average normal direction of the second region 3B.

Further, for example, in a case where the N-th image for composition 142 is obtained by imaging the N-th imaging target region 3, the size of the light source 48 is set to a size in which the light source image 50 (that is, image of reflected light) fits in the image region 142B corresponding to the second region 3B in the N-th image for composition 142.

In the third embodiment, the (N+1)-th imaging target region 3 is an example of “first imaging target region” according to the technology of the present disclosure. The N-th imaging target region 3 is an example of “second imaging target region” according to the technology of the present disclosure. The second region 3B of the (N+1)-th imaging target region 3 is an example of “first region” according to the technology of the present disclosure. The first region 3A of the N-th imaging target region 3 is an example of “second region” according to the technology of the present disclosure.

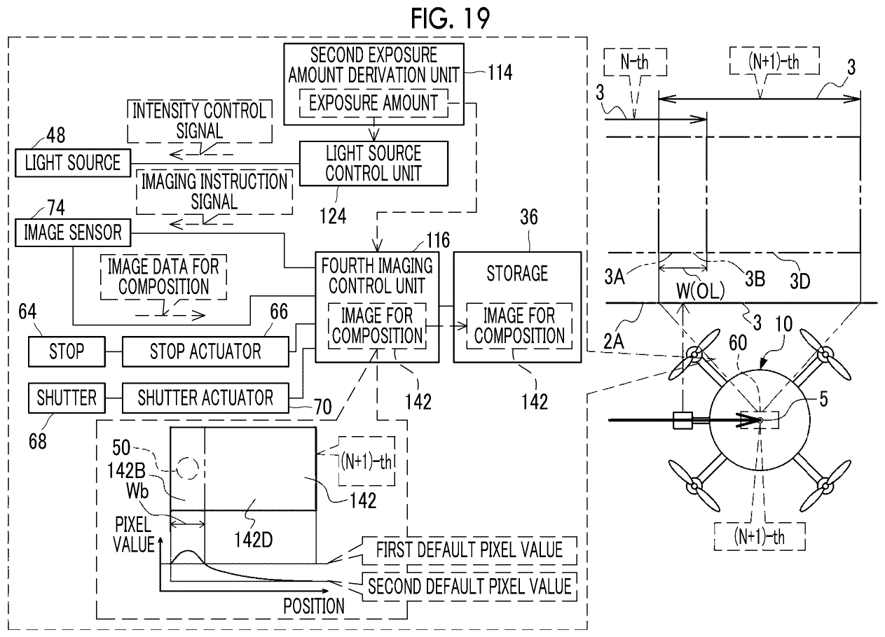

FIG. 19 shows an example of an aspect in which the flying object 20 has reached the (N+1)-th imaging position 5. In the third embodiment, the flight imaging processing is changed as follows, from the first embodiment. That is, in the third embodiment, the processing by the width acquisition unit 104 (refer to FIG. 8) and the processing by the imaging position correction unit 106 (refer to FIG. 9) are omitted. Further, in the third embodiment, the overlap amount OL of the first region 3A and the second region 3B is fixed to the default overlap amount. The exposure amount is derived based on the brightness of a fourth region 3D other than the second region 3B of the (N+1)-th imaging target region 3. The fourth region 3D is an example of “fourth region” according to the technology of the present disclosure.

The exposure amount derived by the second exposure amount derivation unit 114 is set to an exposure amount at which the width of the second region 3B corresponding to a width Wb of the image region 142B (that is, width of the region having the pixel value equal to or larger than the first default pixel value) in the (N+1)-th image for composition 142 matches the overlap amount OL.

In the third embodiment, the processor 34 (refer to FIG. 5) operates as the light source control unit 124. The light source control unit 124 controls the light source 48 to change the intensity of the light emitted from the light source 48. Specifically, the light source control unit 124 changes the light intensity based on the exposure amount derived by the second exposure amount derivation unit 114.

The fourth imaging control unit 116 outputs the imaging instruction signal to the image sensor 74 to cause the image sensor 74 to image the (N+1)-th imaging target region 3. Further, in a case where the image sensor 74 is caused to image the (N+1)-th imaging target region 3, the fourth imaging control unit 116 adjusts the exposure amount of the light-receiving surface 78A (refer to FIG. 3) based on the exposure amount derived by the second exposure amount derivation unit 114.

The exposure amount is adjusted, for example, by changing the exposure to the light-receiving surface 78A. Specifically, the fourth imaging control unit 116 controls the stop actuator 66 to perform control of changing the size of the stop 64 and/or controls the shutter actuator 70 to perform control of changing the shutter speed of the shutter 68, and thus the exposure to the light-receiving surface 78A is changed.

With the control of changing the light intensity by the light source control unit 124, the control of changing the size of the stop 64 by the second imaging control unit 102, and the control of changing the shutter speed of the shutter 68 by the second imaging control unit 102 (hereinafter referred to as “three types of control”), the exposure amount of the light-receiving surface 78A is set to the exposure amount derived by the second exposure amount derivation unit 114

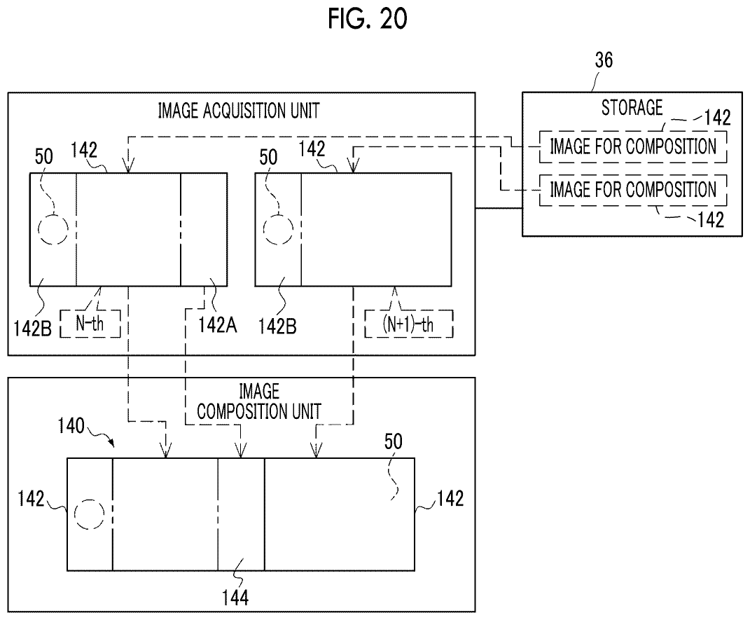

As shown in FIG. 20 as an example, the composite image generation processing is changed as follows in the third embodiment, from the first embodiment. That is, in the third embodiment, the image acquisition unit 132 acquires the N-th image for composition 142 and the (N+1)-th image for composition 142, which are stored in the storage 36. The light source image 50 is included in the image region 142B of the (N+1)-th image for composition 142, and is not included in the image region 142A of the N-th image for composition 142.

The image composition unit 134 composites the N-th image for composition 142 and the

(N+1)-th image for composition 142 to generate the composite image 140. In a case where the composite image 140 is generated, the image composition unit 134 uses the pixel value of the image region 142A in the N-th image for composition 142 as the pixel value of the overlap image region 144 in the composite image 140. Accordingly, the composite image 140 in which the light source image 50 is not included in the overlap image region 144 is obtained.

According to the third embodiment, with the three types of control, the exposure amount of the light-receiving surface 78A is set to the exposure amount derived by the second exposure amount derivation unit 114. Accordingly, since the exposure amount of the light-receiving surface 78A is set to the exposure amount at which the width W of the second region 3B corresponding to the width Wb of the image region 142B (that is, width of the region having the pixel value equal to or larger than the first default pixel value) in the (N+1)-th image for composition 142 matches the overlap amount OL, it is possible to fix the overlap amount OL to the default overlap amount.

Further, since the overlap amount OL is fixed to the default overlap amount, it is possible to improve the efficiency in a case where the plurality of imaging target regions 3 are imaged, as compared with a case where the overlap amount OL is changed to the overlap amount larger than the default overlap amount.

Further, the light source 48 is disposed on the rear side of the flight imaging apparatus 10 in the flying direction with respect to the imaging apparatus 60. Therefore, in a case where the N-th image for composition 142 and the (N+1)-th image for composition 142 are composited to generate the composite image 140, it is possible to avoid including the light source image 50 in the (N+1)-th image for composition 142.

With any one or two types of control of the three types of control, the exposure amount of the light-receiving surface 78A may be set to the exposure amount derived by the second exposure amount derivation unit 114.

Further, the light source 48 may be configured to be capable of changing the irradiation position of the light, and the exposure amount may be adjusted by the change in the irradiation position of the light. Further, the light source 48 may be configured to be capable of changing the irradiation position of the light, and the exposure amount may be adjusted by the change in the irradiation position of the light and the light intensity. Even in this case, it is possible to set the exposure amount of the light-receiving surface 78A to the exposure amount derived by the second exposure amount derivation unit 114.

Further, in a case where the composite image 140 is generated based on the plurality of images for composition 142, the light source image 50 is included in a first image for composition 142 included in the composite image 140. Therefore, for example, in a case where the composite image 140 is generated based on the images for composition 142 of three or more frames, the image region 142B in the first image for composition 142 included in the composite image 140 may be removed from the composite image 140. Further, the second region 3B of the head imaging target region 3 may be a region other than the inspection target region.

The (N+1)-th image for composition 142 is an example of “first captured image” according to the technology of the present disclosure. The N-th image for composition 142 is an example of “second captured image” according to the technology of the present disclosure.

### Fourth Embodiment

Next, a fourth embodiment will be described.

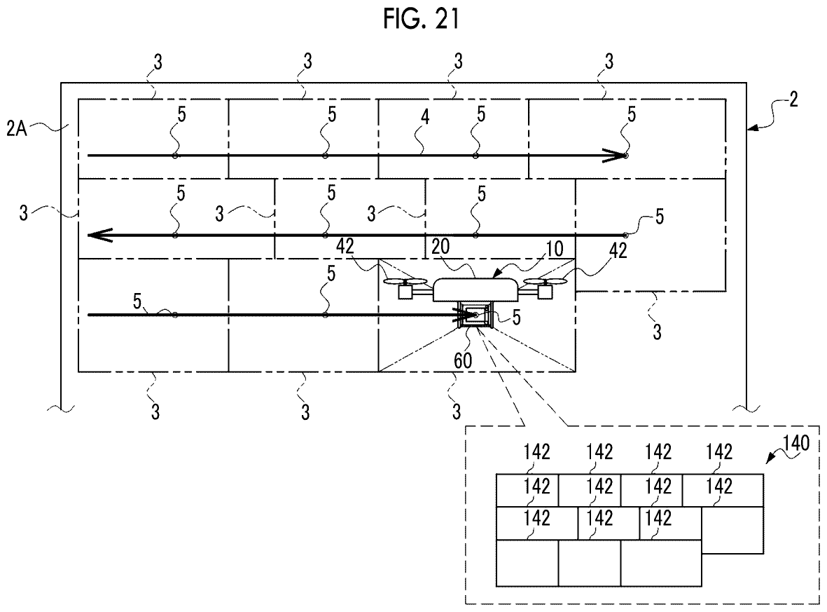

As shown in FIG. 21 as an example, the plurality of flight routes 4 are changed as follows in the fourth embodiment, from the first embodiment. That is, the plurality of flight routes 4 include two types of flight routes 4 having different orientations.

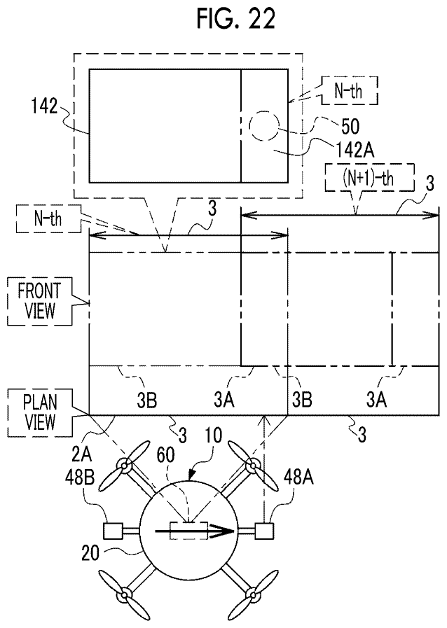

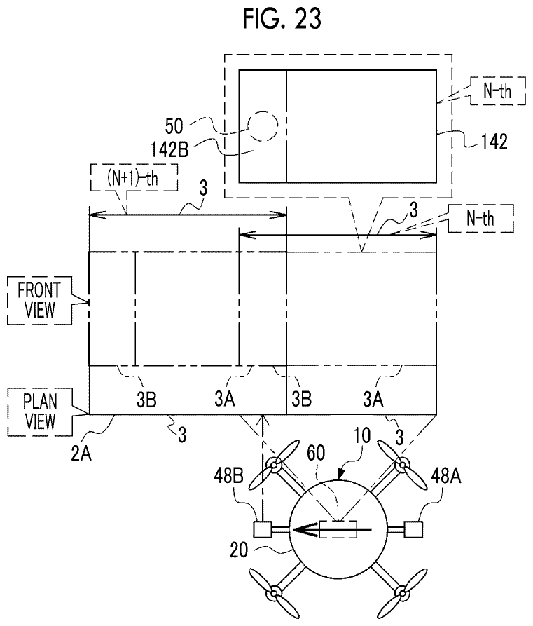

As shown in FIGS. 22 and 23 as an example, the flight imaging apparatus 10 is changed as follows in the fourth embodiment, from the first embodiment. That is, the flight imaging apparatus 10 comprises a first light source 48A and a second light source 48B. The first light source 48A and the second light source 48B are examples of “light source” according to the technology of the present disclosure. The first light source 48A is disposed on a first side (for example, right side) of the flying object 20 in the flying direction with respect to the imaging apparatus 60, and the second light source 48B is disposed on a second side (for example, left side) of the flying object 20 in the flying direction with respect to the imaging apparatus 60.

The first light source 48A and the second light source 48B have the same configuration as the light source 48 according to the first embodiment. The second light source 48B is disposed at a position symmetrical to the first light source 48A of the flying object 20 in the flying direction.

In a case where the flying object 20 flies to the first side, the processor 34 (refer to FIG. 5) causes the first light source 48A, which is disposed on the first side with respect to the imaging apparatus 60, to light. In a case where the flying object 20 flies to the second side, the processor 34 causes the second light source 48B, which is disposed on the second side with respect to the imaging apparatus 60, to light. The flight imaging processing is executed in a case where the flight imaging apparatus 10 starts flying from the start end of each flight route 4. According to the fourth embodiment, even in a case where the plurality of flight routes 4 include the two types of flight routes 4 having different orientations, the imaging apparatus 60 sequentially images the plurality of imaging target regions 3 to obtain the plurality of images for composition 142. Therefore, with the composition of the plurality of images for composition 142, it is possible to generate the composite image 140.

The fourth embodiment may be combined with the third embodiment. In a case where the flying object 20 flies to the first side, the processor 34 may cause the second light source 48B, which is disposed on the second side with respect to the imaging apparatus 60, to light. In a case where the flying object 20 flies to the second side, the processor 34 may cause the first light source 48A, which is disposed on the first side with respect to the imaging apparatus 60, to light. Even in such a case, the imaging apparatus 60 sequentially images the plurality of imaging target regions 3 to obtain the plurality of images for composition 142. Therefore, with the composition of the plurality of images for composition 142, it is possible to generate the composite image 140.

### Fifth Embodiment

Next, a fifth embodiment will be described.

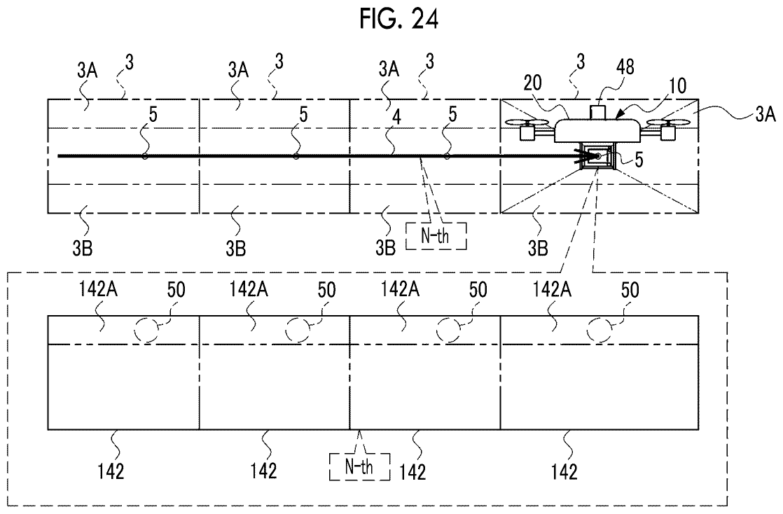

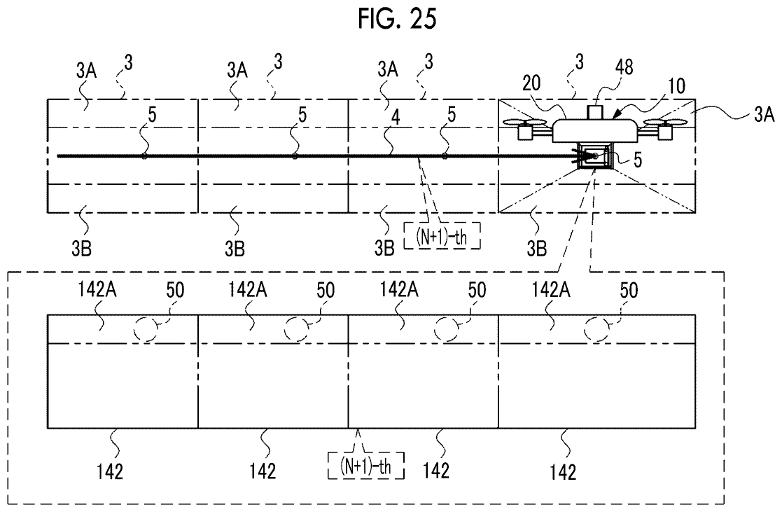

As shown in FIGS. 24 and 25 as an example, the position of the light source 48 is changed as follows in the fifth embodiment, from the first embodiment. That is, the light source 48 is disposed on an upper side with respect to the imaging apparatus 60. The light source 48 irradiates each imaging target region 3 with light. Each imaging target region 3 has a first region 3A and a second region 3B. The first region 3A and the second region 3B are partial regions of the imaging target region 3. The first region 3A is a region of the imaging target region 3 on an upper side, and the second region 3B is a region of the imaging target region 3 on a lower side.

The light source 48 is disposed at a position where the optical axis passes through each first region 3A (center of each first region 3A as an example) in a case where the imaging apparatus 60 images each imaging target region 3. In other words, the light source 48 is disposed at a position where each imaging target region 3 is irradiated with light along a normal direction of each first region 3A in a case where the imaging apparatus 60 images each imaging target region 3. The normal direction may be an average normal direction of the first region 3A. The intensity of the light with which the first region 3A is irradiated is higher than the intensity of the light with which the periphery of the first region 3A is irradiated.

Further, in a case where the image for composition 142 is obtained by imaging the imaging target region 3, the size of the light source 48 is set to a size in which the light source image 50 (that is, image of reflected light) fits in the image region 142A corresponding to the first region 3A in the image for composition 142.

As shown in FIG. 24 as an example, in a case where the flight imaging apparatus 10 performs the imaging while flying along an N-th flight route 4, the plurality of images for composition 142 are obtained for the N-th flight route 4. Similarly, as shown in FIG. 25 as an example, in a case where the flight imaging apparatus 10 performs the imaging while flying along an (N+1)-th flight route 4, the plurality of images for composition 142 are obtained for the (N+1)-th flight route 4.

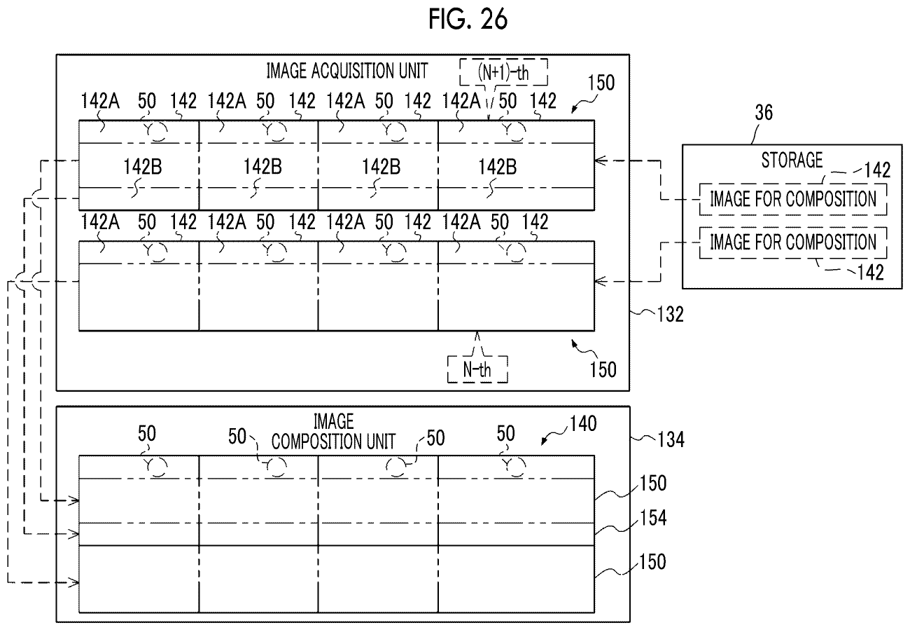

As shown in FIG. 26 as an example, the composite image generation processing is changed as follows in the fifth embodiment, from the first embodiment. That is, in a case where the flight imaging apparatus 10 performs the imaging while flying along the N-th flight route 4, the image composition unit 134 composites the plurality of images for composition 142 obtained for the N-th flight route 4 to generate an N-th composite image 150.

In a case where the flight imaging apparatus 10 performs the imaging while flying along the N-th flight route 4, the flight imaging apparatus 10 moves to the (N+1)-th flight route 4, which is one flight route 4 above the N-th flight route 4, and performs the imaging while flying along the (N+1)-th flight route 4. In a case where the flight imaging apparatus 10 performs the imaging while flying along the (N+1)-th flight route 4, the image composition unit 134 composites the plurality of images for composition 142 obtained for the (N+1)-th flight route 4 to generate an (N+1)-th composite image 150.

The image composition unit 134 composites the N-th composite image 150 and the (N+1)-th composite image 150 to generate the composite image 140. In a case where the composite image 140 is generated, the image composition unit 134 uses the pixel value of the image region 142B in the (N+1)-th composite image 150 as the pixel value of an overlap image region 154 in the composite image 140. Accordingly, it is possible to obtain the composite image 140 in which the light source image 50 is not included in the overlap image region 154.

In the fifth embodiment, the N-th imaging target region 3 is an example of “first imaging target region” according to the technology of the present disclosure. The (N+1)-th imaging target region 3 is an example of “second imaging target region” according to the technology of the present disclosure. The first region 3A is an example of “first region” according to the technology of the present disclosure. The second region 3B is an example of “second region” according to the technology of the present disclosure. The N-th composite image 150 is an example of “first captured image” according to the technology of the present disclosure. The (N+1)-th composite image 150 is an example of “second captured image” according to the technology of the present disclosure.

### Sixth Embodiment

Next, a sixth embodiment will be described.

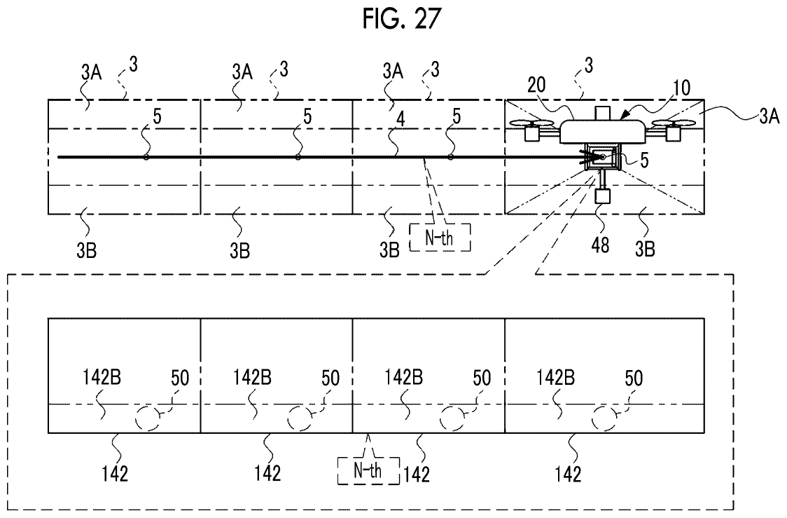

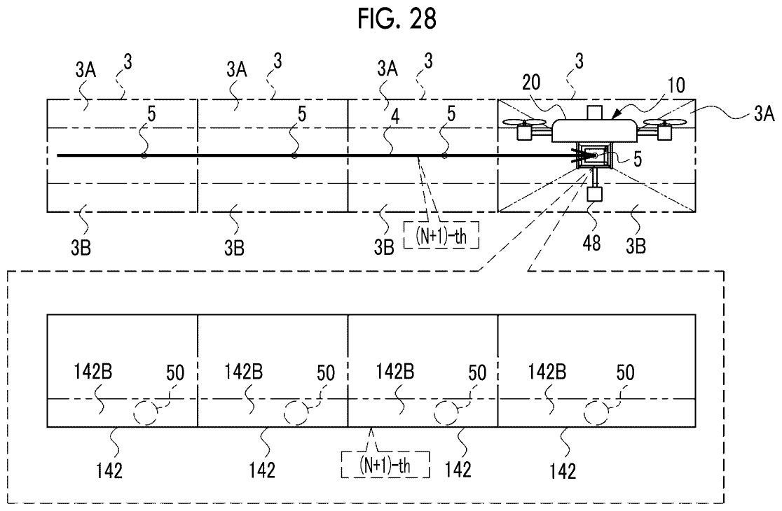

As shown in FIGS. 27 and 28 as an example, the position of the light source 48 is changed as follows in the sixth embodiment, from the third embodiment. That is, the light source 48 is disposed on a lower side with respect to the imaging apparatus 60. The light source 48 irradiates each imaging target region 3 with light. Each imaging target region 3 has a first region 3A and a second region 3B. The first region 3A and the second region 3B are partial regions of the imaging target region 3. The first region 3A is a region of the imaging target region 3 on an upper side, and the second region 3B is a region of the imaging target region 3 on a lower side.

The light source 48 is disposed at a position where the optical axis passes through each second region 3B (center of each second region 3B as an example) in a case where the imaging apparatus 60 images each imaging target region 3. In other words, the light source 48 is disposed at a position where each imaging target region 3 is irradiated with light along a normal direction of each second region 3B in a case where the imaging apparatus 60 images each imaging target region 3. The normal direction may be an average normal direction of the second region 3B. The intensity of the light with which the second region 3B is irradiated is higher than the intensity of the light with which a periphery of the second region 3B is irradiated.

Further, in a case where the image for composition 142 is obtained by imaging the imaging target region 3, the size of the light source 48 is set to a size in which the light source image 50 (that is, image of reflected light) fits in the image region 142B corresponding to the second region 3B in the image for composition 142.

As shown in FIG. 27 as an example, in a case where the flight imaging apparatus 10 performs the imaging while flying along the N-th flight route 4, the plurality of images for composition 142 are obtained for the N-th flight route 4. Similarly, as shown in FIG. 28 as an example, in a case where the flight imaging apparatus 10 performs the imaging while flying along the (N+1)-th flight route 4, the plurality of images for composition 142 are obtained for the (N+1)-th flight route 4.

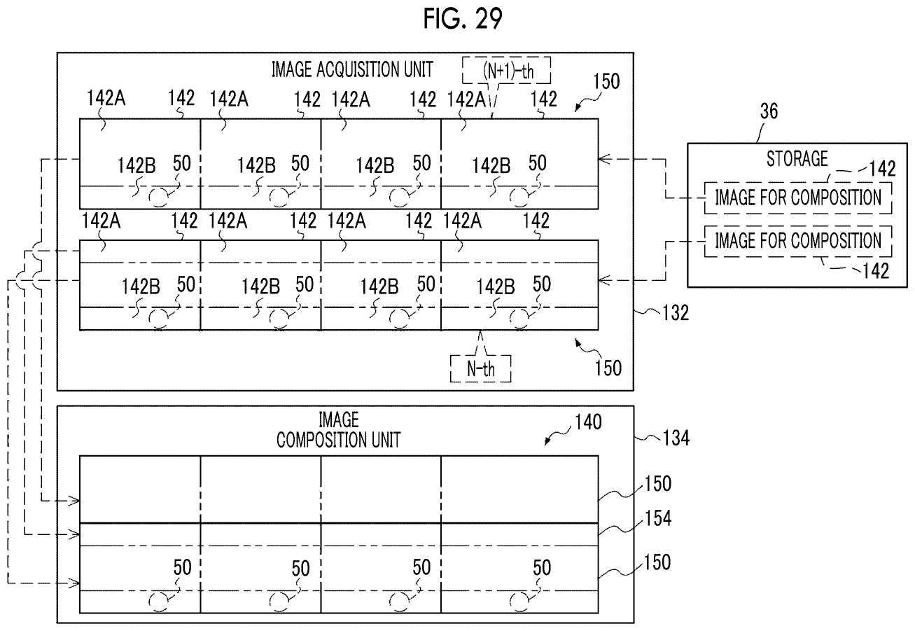

As shown in FIG. 29 as an example, the composite image generation processing is changed as follows in the sixth embodiment, from the third embodiment. That is, in a case where the flight imaging apparatus 10 performs the imaging while flying along the N-th flight route 4, the image composition unit 134 composites the plurality of images for composition 142 obtained for the N-th flight route 4 to generate the N-th composite image 150.

In a case where the flight imaging apparatus 10 performs the imaging while flying along the N-th flight route 4, the flight imaging apparatus 10 moves to the (N+1)-th flight route 4, which is one flight route 4 above the N-th flight route 4, and performs the imaging while flying along the (N+1)-th flight route 4. In a case where the flight imaging apparatus 10 performs the imaging while flying along the (N+1)-th flight route 4, the image composition unit 134 composites the plurality of images for composition 142 obtained for the (N+1)-th flight route 4 to generate the (N+1)-th composite image 150.

The image composition unit 134 composites the N-th composite image 150 and the (N+1)-th composite image 150 to generate the composite image 140. In a case where the composite image 140 is generated, the image composition unit 134 uses the pixel value of the image region 142A in the N-th composite image 150 as the pixel value of the overlap image region 154 in the composite image 140. Accordingly, it is possible to obtain the composite image 140 in which the light source image 50 is not included in the overlap image region 154.

In the sixth embodiment, the (N+1)-th imaging target region 3 is an example of “first imaging target region” according to the technology of the present disclosure. The N-th imaging target region 3 is an example of “second imaging target region” according to the technology of the present disclosure. The second region 3B of the (N+1)-th imaging target region 3 is an example of “first region” according to the technology of the present disclosure. The first region 3A of the N-th imaging target region 3 is an example of “second region” according to the technology of the present disclosure. The (N+1)-th composite image 150 is an example of “first captured image” according to the technology of the present disclosure. The N-th composite image 150 is an example of “second captured image” according to the technology of the present disclosure.

Next, modification examples common to the first to sixth embodiments will be described.

In the above embodiment, the lighting control unit 92 causes the light source 48 to light in a case where the flight imaging apparatus 10 starts flying along the flight route 4, and the extinguishing control unit 120 causes the light source 48 to be extinguished in a case where the flight imaging apparatus 10 ends the flying along the flight route 4. However, the lighting control unit 92 may cause the light source 48 to light in a case where the flight imaging apparatus 10 reaches each imaging position 5 on the flight route 4, and the extinguishing control unit 120 may cause the light source 48 to be extinguished in a case where the flight imaging apparatus 10 acquires the image for composition 142 at each imaging position 5.

In this manner, it is possible to reduce power supplied to the light source 48, as compared with a case where the light source 48 lights in a case where the flight imaging apparatus 10 starts the flying along the flight route 4 and the light source 48 is extinguished in a case where the flight imaging apparatus 10 ends the flying along the flight route 4. The control by the lighting control unit 92 in this case is an example of “control of causing the light source to perform the light irradiation in a case where the moving object is moved to a position where the imaging apparatus images the first imaging target region” according to the technology of the present disclosure.

Further, in the above embodiment, in a case where the N-th image for composition 142 is obtained by imaging the N-th imaging target region 3, the size of the light source 48 is set to a size in which the light source image 50 (that is, image of reflected light) fits in the image region 142A in the N-th image for composition 142.

However, the processor 34 may perform control of making the light source image 50 fit in the image region 142A in the image for composition 142. Examples of the control of making the light source image 50 fit in the image region 142A include control of increasing or decreasing the intensity of the light emitted from the light source 48, control of changing the position of the light source 48, control of changing an angle of the light source 48, and control of changing the distance between the wall surface 2A and the flight imaging apparatus 10. Even in this manner, with the avoidance of the use of the pixel value of the image region 142A in the N-th image for composition 142 as the pixel value of the overlap image region 144, it is possible to obtain the composite image 140 that does not include the light source image 50.

Further, in the above embodiment, the brightness of the imaging target region 3 is acquired based on the captured image obtained by being captured by the imaging apparatus 60. However, the brightness of the imaging target region 3 may be acquired based on a captured image obtained by being captured by a bird's-eye view camera (not shown) that images the wall surface 2A. Further, the flight imaging apparatus 10 may be provided with a sensor (not shown) that detects the brightness of the imaging target region 3 separately from the imaging apparatus 60, and the brightness of the imaging target region 3 may be acquired based on a detection result of the sensor.

Further, in the above embodiment, the image for composition 142 is acquired in a state where the flight imaging apparatus 10 is temporarily stopped at each imaging position 5. However, for example, in a case where the brightness of the imaging target region 3 is acquired by using the bird's-eye view camera or the sensor, the flight imaging apparatus 10 may acquire the image for composition 142 while passing through each imaging apparatus 60.

Further, in the above embodiment, the flying object 20 is illustrated as an example of the moving object, but any moving object may be employed as long as the moving object moves on the movement route. Examples of the moving object include a car, a motorcycle, a bicycle, a cart, a gondola, an airplane, a flying object, and a ship.

Further, in the above embodiment, the flight route 4 extends in the horizontal direction, but may extend in a direction other than the horizontal direction. Further, the orientation of the flight route 4 may also be changed with respect to the orientation shown in each figure.

Further, in the above embodiment, the processor 34 is illustrated, but at least one CPU, at least one GPU, and/or at least one TPU may be used instead of the processor 34 or together with the processor 34.

Further, in the above embodiment, the form example has been described in which the storage 36 stores the flight imaging program 90 and the composite image generation program 130, but the technology of the present disclosure is not limited thereto. For example, the flight imaging program 90 and/or the composite image generation program 130 may be stored in a portable non-transitory computer-readable storage medium (hereinafter simply referred to as “non-transitory storage medium”) such as an SSD or a USB memory. The flight imaging program 90 and/or the composite image generation program 130 stored in the non-transitory storage medium may be installed in the computer 26 of the flight imaging apparatus 10.

Further, the flight imaging program 90 and/or the composite image generation program 130 may be stored in a storage device of another computer, a server device, or the like connected to the flight imaging apparatus 10 via a network, and the flight imaging program 90 and/or the composite image generation program 130 may be downloaded in response to a request of the flight imaging apparatus 10 to be installed in the computer 26.

Further, there is no need to store all of the flight imaging program 90 and/or the composite image generation program 130 in the storage device of another computer, a server device, or the like connected to the flight imaging apparatus 10 or the storage 36, and a part of the flight imaging program 90 and/or the composite image generation program 130 may be stored.

While the computer 26 is built in the flight imaging apparatus 10, the technology of the present disclosure is not limited thereto. For example, the computer 26 may be provided outside the flight imaging apparatus 10.

Further, in the above embodiment, although the computer 26 including the processor 34, the storage 36, and the RAM 38 is illustrated, the technology of the present disclosure is not limited thereto, and a device including an ASIC, an FPGA, and/or a PLD may be applied instead of the computer 26. Further, a hardware configuration and a software configuration may be used in combination, instead of the computer 26.

Further, the following various processors can be used as a hardware resource for executing the various types of processing described in the above embodiment. Examples of the processor include a CPU that is a general-purpose processor functioning as the hardware resource for executing the various types of processing by executing software, that is, a program. Examples of the processor also include a dedicated electronic circuit such as an FPGA, a PLD, or an ASIC that is a processor having a circuit configuration dedicatedly designed to execute specific processing. Any processor includes a memory built therein or connected thereto, and any processor uses the memory to execute various types of processing.

The hardware resource for executing various types of processing may be configured by one of the various processors or may be configured by a combination of two or more processors that are the same type or different types (for example, combination of a plurality of FPGAs or combination of a CPU and an FPGA). Further, the hardware resource for executing the various types of processing may be one processor.

As a configuration example of one processor, first, there is a form in which one processor is configured by a combination of one or more CPUs and software and the processor functions as the hardware resource for executing the various types of processing. Second, as represented by an SoC or the like, a form of using a processor that implements functions of the entire system including a plurality of hardware resources for executing the various types of processing in one IC chip is included. As described above, the various types of processing are implemented by using one or more of the various processors as the hardware resource.

Furthermore, as the hardware structure of these various processors, more specifically, it is possible to use an electronic circuit in which circuit elements, such as semiconductor elements, are composited. The various types of processing is merely an example. Accordingly, it goes without saying that unnecessary steps may be deleted, new steps may be added, or the processing order may be changed within a range that does not deviate from the gist.

The contents described and the contents shown hereinabove are specific descriptions regarding the part according to the technique of the present disclosure and are merely examples of the technique of the present disclosure. For example, the descriptions regarding the configurations, the functions, the actions, and the effects are descriptions regarding an example of the configurations, the functions, the actions, and the effects of the part according to the technology of the present disclosure. Accordingly, in the contents described and the contents shown hereinabove, it is needless to say that removal of an unnecessary part, or addition or replacement of a new element may be employed within a range not departing from the gist of the present technology of the present disclosure. In order to avoid complication and easily understand the part according to the technique of the present disclosure, in the contents described and the contents shown hereinabove, the description regarding common general technical knowledge or the like which is not necessarily particularly described for enabling implementation of the technique of the present disclosure is omitted.

In the present specification, “A and/or B” is identical to “at least one of A or B”. That is, “A and/or B” may be only A, only B, or a combination of A and B. In the present specification, the same description regarding “A and/or B” is applied also in a case of expressing three or more items with the expression of “and/or”.

In a case where all of documents, patent applications, and technical standard described in the specification are incorporated in the specification as references, to the same degree as a case where the incorporation of each of documents, patent applications, and technical standard as references is specifically and individually noted.

Further, the following Supplementary Note will be disclosed with respect to the above embodiments.

### Supplementary Note 1

An image processing apparatus comprising:

a processor,

wherein the processor is configured to, in a case where an imaging apparatus images a first imaging target region and a second imaging target region of a subject according to a movement position of a moving object equipped with the imaging apparatus, composite a first captured image obtained by imaging the first imaging target region and a second captured image obtained by imaging the second imaging target region to generate a composite image,

a first region that is a part of the first imaging target region overlaps with a second region that is a part of the second imaging target region,

the first captured image is an image obtained by imaging the first imaging target region by the imaging apparatus in a state where the first imaging target region is irradiated with light by a light source mounted on the moving object,

an intensity of the light with which the first region is irradiated is higher than an intensity of the light with which a periphery of the first region is irradiated, and the composite image is an image in which a pixel value of an image region corresponding to the second region in the second captured image is used as a pixel value of an overlap image region corresponding to the first region and the second region in the composite image.

### Supplementary Note 2

An image processing method comprising:

in a case where an imaging apparatus images a first imaging target region and a second imaging target region of a subject according to a movement position of a moving object equipped with the imaging apparatus, compositing a first captured image obtained by imaging the first imaging target region and a second captured image obtained by imaging the second imaging target region to generate a composite image,

wherein a first region that is a part of the first imaging target region overlaps with a second region that is a part of the second imaging target region,

the first captured image is an image obtained by imaging the first imaging target region by the imaging apparatus in a state where the first imaging target region is irradiated with light by a light source mounted on the moving object,

an intensity of the light with which the first region is irradiated is higher than an intensity of the light with which a periphery of the first region is irradiated, and

the composite image is an image in which a pixel value of an image region corresponding to the second region in the second captured image is used as a pixel value of an overlap image region corresponding to the first region and the second region in the composite image.

### Supplementary Note 3

A program for causing a computer to execute a process, the process comprising:

in a case where an imaging apparatus images a first imaging target region and a second imaging target region of a subject according to a movement position of a moving object equipped with the imaging apparatus, compositing a first captured image obtained by imaging the first imaging target region and a second captured image obtained by imaging the second imaging target region to generate a composite image,

wherein a first region that is a part of the first imaging target region overlaps with a second region that is a part of the second imaging target region,

the first captured image is an image obtained by imaging the first imaging target region by the imaging apparatus in a state where the first imaging target region is irradiated with light by a light source mounted on the moving object,

an intensity of the light with which the first region is irradiated is higher than an intensity of the light with which a periphery of the first region is irradiated, and

the composite image is an image in which a pixel value of an image region corresponding to the second region in the second captured image is used as a pixel value of an overlap image region corresponding to the first region and the second region in the composite image.

### Supplementary Note 4

A mobile imaging apparatus comprising:

an imaging apparatus;

a light source; and

a moving object equipped with the imaging apparatus and the light source,

wherein the imaging apparatus images a first imaging target region and a second imaging target region of a subject according to a movement position of the moving object,

a first region that is a part of the first imaging target region overlaps with a second region that is a part of the second imaging target region,

the light source irradiates the first imaging target region with light, and

an intensity of the light with which the first region is irradiated is higher than an intensity of the light with which a periphery of the first region is irradiated.

### Supplementary Note 5

The mobile imaging apparatus according to Supplementary Note 4, further comprising:

a control device that controls the imaging apparatus and the light source.

What is claimed is:

1. A control device applied to a moving object equipped with an imaging apparatus and a light source,
in which the imaging apparatus images a first imaging target region and a second imaging target region of a subject according to a movement position of the moving object, and
a first region that is a part of the first imaging target region overlaps with a second region that is a part of the second imaging target region,
the control device comprising a processor,
wherein the processor is configured to perform control of causing the light source to irradiate the first imaging target region with light, and
an intensity of the light with which the first region is irradiated is higher than an intensity of the light with which a periphery of the first region is irradiated.

2. The control device according to claim 1,
wherein the processor is configured to:
composite a first captured image obtained by imaging the first imaging target region and a second captured image obtained by imaging the second imaging target region to generate a composite image; and
use, in a case where the composite image is generated, a pixel value of an image region corresponding to the second region in the second captured image as a pixel value of an overlap image region corresponding to the first region and the second region in the composite image.

3. The control device according to claim 1,
wherein the control includes control of making an image of the light source fit in an image region corresponding to the first region in a first captured image obtained by imaging the first imaging target region.

4. The control device according to claim 1,
wherein the imaging apparatus includes an image sensor having a light-receiving surface, and
the processor is configured to, in a case where the imaging apparatus images the first imaging target region, adjust an exposure amount of the light-receiving surface based on brightness of a third region other than the first region of the first imaging target region.

5. The control device according to claim 4,
wherein the exposure amount is adjusted by changing an irradiation position and/or an intensity of the light.

6. The control device according to claim 4,
wherein the exposure amount is adjusted by changing exposure to the light-receiving surface.

7. The control device according to claim 4,
wherein the exposure amount is set to an exposure amount at which a pixel value of an image region corresponding to the first region in a first captured image obtained by imaging the first imaging target region is equal to or larger than a first default pixel value.

8. The control device according to claim 7,
wherein the first default pixel value is set to a pixel value at which a pixel value of at least a part of the image region is saturated.

9. The control device according to claim 7,
wherein the first imaging target region and the second imaging target region are regions that are imaged in an order of the first imaging target region and the second imaging target region, and
the processor is configured to:
acquire a length of the first region along a movement direction of the moving object based on the pixel value of the image region; and
move, based on the length, the moving object to a position where the first region and the second region overlap each other.

10. The control device according to claim 7,
wherein the exposure amount is set to an exposure amount at which a pixel value of an image region corresponding to the third region in the first captured image is equal to or larger than a second default pixel value and less than the first default pixel value.

11. The control device according to claim 10,
wherein an overlap amount with which the first region and the second region overlap is a default overlap amount.

12. The control device according to claim 1,
wherein the light source is disposed on a front side of the moving object in a movement direction with respect to the imaging apparatus, and
the first imaging target region and the second imaging target region are regions that are imaged in an order of the first imaging target region and the second imaging target region.

13. The control device according to claim 1,
wherein the light source is disposed on a rear side of the moving object in a movement direction with respect to the imaging apparatus, and
the first imaging target region and the second imaging target region are regions that are imaged in an order of the second imaging target region and the first imaging target region.

14. The control device according to claim 1,
wherein the processor is configured to, in a case where the imaging apparatus images the second imaging target region, perform control of causing the light source to irradiate the second imaging target region with the light, and
an intensity of the light with which a fourth region on a side opposite to the second region of the second imaging target region is irradiated is higher than an intensity of the light with which a periphery of the fourth region is irradiated.

15. The control device according to claim 1,
wherein light irradiation is performed along a normal direction of the first region.

16. The control device according to claim 1,
wherein the control is control of causing the light source to be in a state of performing irradiation with the light in a case where the moving object is moved to a position where the imaging apparatus images the first imaging target region.

17. The control device according to claim 1,
wherein the control is control of causing the light source to perform irradiation with the light in a case where the moving object is moved to a position where the imaging apparatus images the first imaging target region.

18. A control method applied to a moving object equipped with an imaging apparatus and a light source,
in which the imaging apparatus images a first imaging target region and a second imaging target region of a subject according to a movement position of the moving object, and
a first region that is a part of the first imaging target region overlaps with a second region that is a part of the second imaging target region,
the control method comprising performing control of causing the light source to irradiate the first imaging target region with light,
wherein an intensity of the light with which the first region is irradiated is higher than an intensity of the light with which a periphery of the first region is irradiated.

19. A non-transitory computer-readable storage medium storing a program for causing a computer, which is applied to a moving object equipped with an imaging apparatus and a light source, to execute a process,
in which the imaging apparatus images a first imaging target region and a second imaging target region of a subject according to a movement position of the moving object, and
a first region that is a part of the first imaging target region overlaps with a second region that is a part of the second imaging target region,
the process comprising performing control of causing the light source to irradiate the first imaging target region with light,
wherein an intensity of the light with which the first region is irradiated is higher than an intensity of the light with which a periphery of the first region is irradiated.
